(19) United States
(12) Patent Application Publication
(10) Pub. No.: US 2025/0014375 A1
(43) Pub. Date: Jan. 9, 2025

(54) INFORMATION PROCESSING APPARATUS, CONTROL METHOD FOR INFORMATION PROCESSING APPARATUS, AND STORAGE MEDIUM

(71) Applicant: CANON KABUSHIKI KAISHA, Tokyo (JP)

(72) Inventor: AKIKO ITO, Kanagawa (JP)

(21) Appl. No.: 18/762,229

(22) Filed: Jul. 2, 2024

(30) Foreign Application Priority Data
Jul. 6, 2023 (JP) 2023-111114

(51) Int. Cl. G06V 30/19; G06V 10/94; G06V 30/148; G06V 30/413; H04N 1/44

(52) U.S. Cl. CPC G06V 30/19173; G06V 10/945; G06V 30/153; G06V 30/413; H04N 1/4493

(57) ABSTRACT

An information processing apparatus performs operations including, based on recognition processing for identifying a classification of image data, identifying a classification of the image data from among a plurality of classifications, searching for a character string falling into a category associated with the identified classification from among a plurality of character strings included in the image data, and performing masking processing on the searched-for character string in the image data, wherein each of the plurality of classifications are associated with different categories.

### BACKGROUND

### Field of the Disclosure

Aspects of the present disclosure generally relate to a technique which performs masking processing on image data.

### Description of the Related Art

Known techniques for use in sharing, with another person, a document containing information intended to be concealed, such as personal information or confidential information, include a technique which performs masking processing on a region intended to be concealed included in the document. The masking processing includes, for example, a method of generating a composite image which is obtained by superposing a mask image on a region intended to be concealed.

Japanese Patent Application Laid-Open No. 2012-234344 discusses a technique which searches for a plurality of character strings corresponding to a plurality of items set as a target for masking processing from surroundings of the items subjected to character recognition on a business-form image and performs masking processing on a rectangle circumscribing the plurality of character strings.

However, the technique discussed in Japanese Patent Application Laid-Open No. 2012-234344 is not able to perform masking processing on character strings corresponding to items which differ for each type of image data set as a target for masking processing.

### SUMMARY

Aspects of the present disclosure are generally directed to enabling performing masking processing on character strings falling into items which differ for each type of image data.

According to an aspect of the present disclosure, an information processing apparatus includes at least one memory that stores instructions, and at least one processor that executes the instructions to perform operations including, based on recognition processing for identifying a classification of image data, identifying a classification of the image data from among a plurality of classifications, searching for a character string falling into a category associated with the identified classification from among a plurality of character strings included in the image data, and performing masking processing on the searched-for character string in the image data, wherein each of the plurality of classifications are associated with different categories.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of an image processing system.

FIG. 2 is a diagram illustrating a hardware configuration example of an information processing apparatus constituting the image processing system.

FIG. 3 is a diagram illustrating a hardware configuration example of an external storage constituting the image processing system.

FIG. 4 is a diagram illustrating a software configuration example of the information processing apparatus constituting the image processing system.

FIG. 5 is a flowchart illustrating the entire processing which the image processing system performs.

FIG. 6 is a flowchart illustrating scan setting screen display processing which the image processing system performs.

FIG. 7 is a flowchart illustrating masking region identification processing which the image processing system performs.

FIG. 8 is a flowchart illustrating masking edit processing which the image processing system performs.

FIG. 9 is a flowchart illustrating preset registration processing which the image processing system performs.

FIGS. 10A, 10B, 10C, 10D, 10E, 10F, 10G, and 10H are diagrams illustrating screen structure examples of the image processing system.

FIG. 11 is a diagram illustrating a screen structure example of the image processing system.

FIG. 12 is a diagram illustrating a screen structure example of the image processing system.

FIG. 13 is a flowchart illustrating information classification acquisition processing which the image processing system performs.

FIG. 14 is a diagram illustrating a screen structure example of the image processing system.

FIG. 15 is a flowchart illustrating information classification acquisition processing which the image processing system performs.

FIG. 16 is a diagram illustrating a screen structure example of the image processing system.

FIG. 17 is a diagram illustrating a screen structure example of the image processing system.

FIG. 18 is a flowchart illustrating masking region identification processing which the image processing system performs.

### DESCRIPTION OF THE EMBODIMENTS

Various exemplary embodiments, features, and aspects of the disclosure will be described in detail below with reference to the drawings. Furthermore, the following exemplary embodiments are not intended to limit the disclosure set forth in claims, and not all of the combinations of characteristics described in each exemplary embodiment are necessarily essential for the solutions in the disclosure.

### <Overall Configuration>

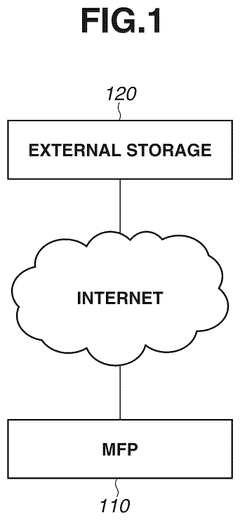

FIG. 1 is a diagram illustrating an overall configuration of an image processing system in a first exemplary embodiment. The image processing system illustrated in FIG. 1 includes a multifunction peripheral (MFP) 110 and an external storage 120. The MFP 110 is connected to a server which provides various services on the Internet via a local area network (LAN).

The MFP 110 is a multifunction peripheral having a plurality of functions such as a scanner and a printer, and is an example of an information processing apparatus in the first exemplary embodiment. The MFP 110 also has the function of transferring a scanned image file to a service capable of performing file storage such as an external storage service. Furthermore, the information processing apparatus in the first exemplary embodiment is not limited to a multifunction peripheral having a scanner and a printer, and can be a personal computer (PC).

The external storage (service) 120 is a service capable of storing a file received via the Internet and acquiring a file from an external apparatus via a web browser. The external storage 120 is, for example, a cloud service. The number of external storages 120 is not limited to one but can be two or more.

While the image processing system in the first exemplary embodiment is configured to include the MFP 110 and the external storage 120, the first exemplary embodiment is not limited to this. For example, some functions and processing operations of the MFP 110 can be performed by a separate server arranged on the Internet or on a LAN. Moreover, the external storage 120 can be arranged not on the Internet but on a LAN. Additionally, the external storage 120 can be replaced by, for example, a mail server to enable attaching a scanned image to an e-mail and transmitting the e-mail with the scanned image attached thereto. The MFP 110 can be configured to also include the storage function of the external storage 120.

### <Hardware Configuration of MFP>

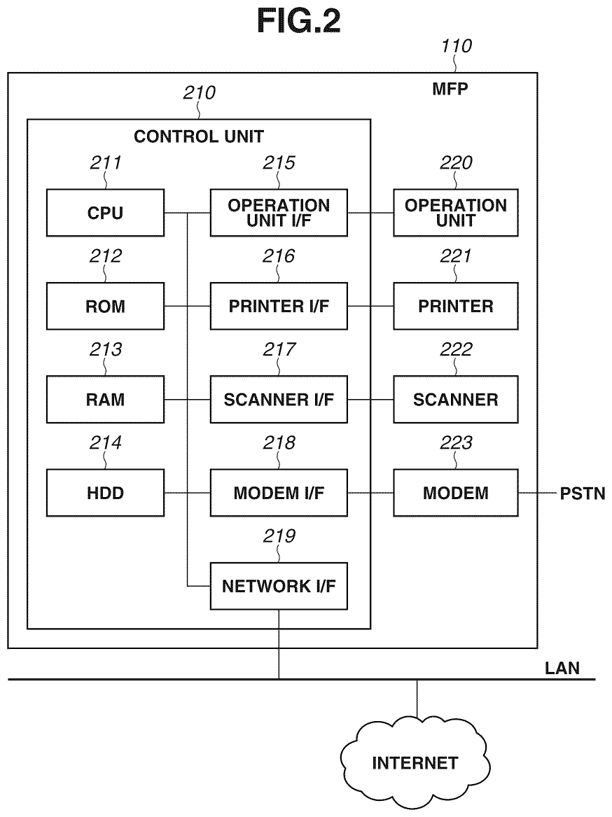

FIG. 2 is a hardware configuration diagram of the MFP 110. The MFP 110 is configured with a control unit 210, an operation unit 220, a printer 221, a scanner 222, and a modem 223. The control unit 210 is configured with the following units 211 to 219 and controls an operation of the entire MFP 110. A central processing unit (CPU) 211 reads out a control program stored in a read-only memory (ROM) 212 or a hard disk drive (HDD) 214 and executes the read-out control program to perform and control the various functions included in the MFP 110, such as reading, printing, and communication. A random access memory (RAM) 213 is used as a temporarily storage region, such as a main memory or work area, for the CPU 211. Furthermore, while, in the first exemplary embodiment, a single CPU 211 is assumed to perform respective processing operations illustrated in flowcharts described below with use of a single memory (RAM 213 or HDD 214), the first exemplary embodiment is not limited to this.

For example, a plurality of CPUs and a plurality of RAMs or HDDs can cooperate to perform the respective processing operations. The HDD 214 is a high-capacity storage unit which stores image data and various programs.

An operation unit interface (I/F) 215 is an interface which connects the operation unit 220 and the control unit 210 to each other. The operation unit 220 is equipped with, for example, a touch panel and a keyboard, and receives an operation, an input, and an instruction performed by the user. A printer I/F 216 is an interface which connects the printer 221 and the control unit 210 to each other. Image data for printing is transferred from the control unit 210 to the printer 221 via the printer I/F 216 and is then printed on a recording medium. A scanner I/F 217 is an interface which connects the scanner 222 and the control unit 210 to each other. The scanner 222 reads an original, which has been set on a document positioning plate or an automatic document feeder (ADF) (not illustrated), to generate image data, and inputs the image data to the control unit 210 via the scanner I/F 217. The MFP 110 is able to not only perform print outputting (copying) of image data generated by the scanner 222 from the printer 221 but also perform file transmission or e-mail transmission of the image data. A modem I/F 218 is an interface which connects the modem 223 and the control unit 210 to each other. The modem 223 performs facsimile communication of image data between the MFP 110 and a facsimile apparatus located on a public switched telephone network (PSTN). A network I/F 219 is an interface which connects the control unit 210 (MFP 110) to a LAN. The MFP 110 uses the network I/F 219 to transmit image data or information to various services on the Internet and receive various pieces of information from the various services.

### <Hardware Configuration of External Storage>

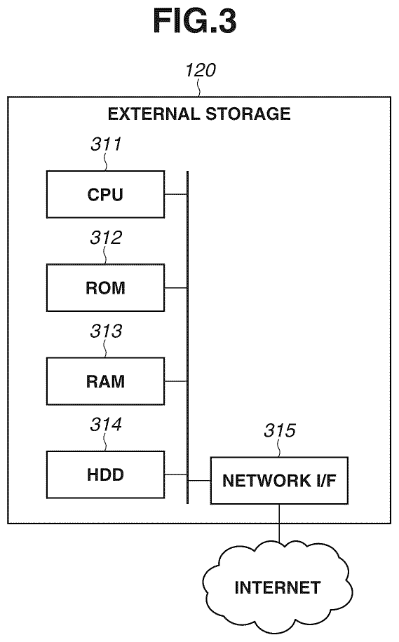

FIG. 3 is a hardware configuration diagram of the external storage 120. The external storage 120 is configured with a CPU 311, a ROM 312, a RAM 313, an HDD 314, and a network I/F 315. The CPU 311 reads out a control program stored in the ROM 312 and performs various processing operations, thus controlling the entire operation of the external storage 120. The RAM 313 is used as a temporary storage region such as a main memory or work area for the CPU 311. The HDD 314 is a high-capacity storage unit which stores image data and various programs. The network I/F 315 is an interface which connects the external storage 120 to the Internet. Upon receiving a processing request from another apparatus (for example, the MFP 110) via the network I/F 315, the external storage 120 transmits or receives various pieces of information.

### <Software Configuration of MFP>

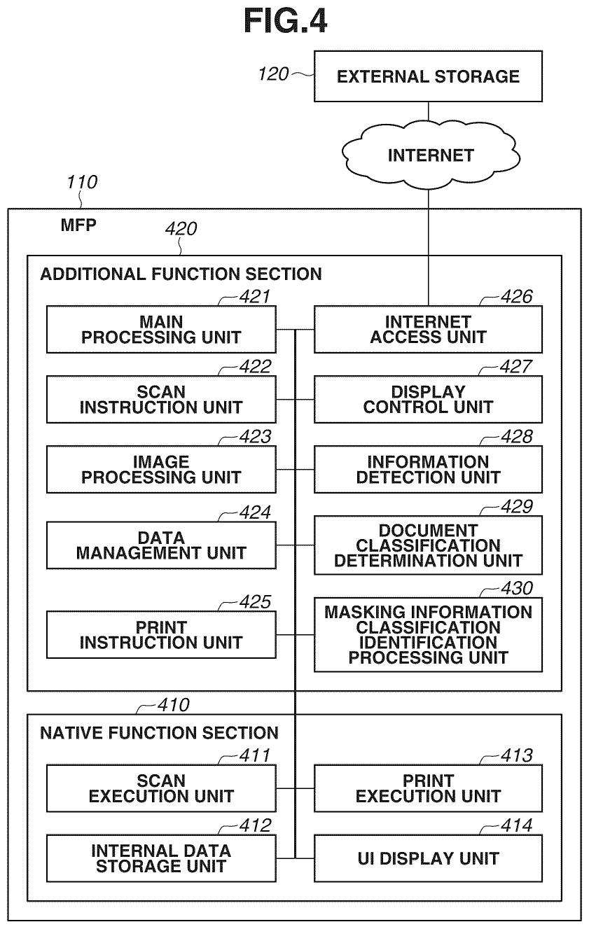

FIG. 4 is a software configuration diagram of the image processing system in the first exemplary embodiment. The MFP 110 is roughly divided into two sections, i.e., a native function section 410 and an additional function section 420. The native function section 410 and the additional function section 420 are implemented by the CPU 211 of the MFP 110 reading out a program stored in the ROM 212 or the HDD 214 onto the RAM 213 and executing the program. While respective units included in the native function section 410 are the ones normally included in the MFP 110, the additional function section 420 is an application additionally installed on the MFP 110. The additional function section 420 is an application that is based on Java®, thus enabling easily implementing function addition to the MFP 110. Furthermore, another additional application (not illustrated) can be previously installed on the MFP 110.

The native function section 410 includes a scan execution unit 411, an internal data storage unit 412, a print execution unit 413, and a user interface (UI) display unit 414. The additional function section 420 includes software modules 421 to 430. Specifically, the software modules 421 to 430 are a main processing unit 421, a scan instruction unit 422, an image processing unit 423, a data management unit 424, a print instruction unit 425, an Internet access unit 426, a display control unit 427, an information detection unit 428, a document classification determination unit 429, and a masking information classification identification processing unit 430.

The main processing unit 421 has the function of managing the general processing operations regarding the additional function section 420. Specifically, the main processing unit 421 controls the entire processing operations of the additional function section 420 and requests the units included in the additional function section 420 to perform respective processing operations.

The scan instruction unit 422 requests the scan execution unit 411 to perform scan processing according to the scan setting input via a UI screen. The scan execution unit 411 receives a scan request including the scan setting from the scan instruction unit 422. In response to the scan request, the scan execution unit 411 causes the scanner 222 via the scanner I/F 217 to read an original placed on the document positioning plate glass to generate scanned image data. The generated scanned image data is sent to the internal data storage unit 412. The scan execution unit 411 sends an image identifier uniquely indicating the stored scanned image data to the scan instruction unit 422. The image identifier is, for example, a number, a symbol, or an alphabet (not illustrated) for uniquely identifying, for example, an image obtained by scanning performed in the MFP 110. The internal data storage unit 412 stores the scanned image data received from the scan execution unit 411 in the HDD 214.

The image processing unit 423 performs analysis processing and alteration processing on a scanned image, including masking processing. The image processing unit 423 receives an image identifier from the scan instruction unit 422, and acquires scanned image data corresponding to the image identifier from the internal data storage unit 412. The image processing unit 423 performs recognition processing on an image, such as character region analysis, optical character recognition (OCR), and image rotation or inclination correction in the acquired image data. Moreover, the image processing unit 423 superposes a mask image on a partial region in the scanned image (hereinafter referred to as a “masking region”), combines the scanned image and the mask image to generate mask composite image data, and instructs the internal data storage unit 412 to store the generated mask composite image data. In the first exemplary embodiment, the masking region is a rectangular region used for masking in a scanned image, and is a region represented by information indicating the coordinates of a starting point and an ending point of the rectangular region. For example, the masking region is represented by information indicating the coordinates of a starting point and an ending point of the rectangular region, such as “(441, 957), (1369, 1057)”. While, in the first exemplary embodiment, the masking region is set as a rectangular region, the shape of the masking region can be any shape, such as an oval shape or a triangle shape. The mask image is an image to be used for composition to perform masking processing on the masking region on the scanned image data. The mask image can be an image filled with black or can be an image with the same color as the background color of the scanned image. Moreover, the mask image can be any other kind of image as long as it is an image available for masking a character string included in a masking region within the scanned image. The image processing unit 423 sends the image identifier to the print instruction unit 425, the data management unit 424, or the Internet access unit 426 according to an output setting set to an image subjected to mask composition. The masking processing in the first exemplary embodiment is processing for superposing a mask image on a partial region within the scanned image to conceal information present in the partial region. The mask image can be a rectangle or any other shape. The mask image can be an image filled with black, can be an image filled with white, or can be an image filled with another color. Moreover, the mask image can be not only a one-color image but also a patterned image. Moreover, instead of superposing a mask image on a partial region within the scanned image, processing for erasing pixels contained in the partial region can be performed. For example, if the scanned image is a monochroic image, processing for erasing black pixels contained in the partial region can be performed. Moreover, in the case of, for example, a Portable Document Format (PDF) file, text data within an image obtained as a result of OCR processing performed on the image may be retained in the file. In that case, the masking processing can be processing for creating a mask composite image obtained by superposing a mask image on a partial region within the scanned image and, additionally, erasing text data contained in the partial region. Such masking processing is also called “blacking-out” or “redaction”.

The data management unit 424 retains information about, for example, information classification, document classification, file name, and storage destination set by masking region identification processing and masking edit processing described below, while associating the information with an image identifier. Moreover, the data management unit 424 stores the information classification, document classification, file name, and storage destination set by masking region identification processing and masking edit processing as a preset in the HDD 214. The preset is a template in which information indicating the name of the preset, the coordinates representing a masking region within the scanned image, a character string included in the masking region, information classification, and the file name and storage destination of a file containing the scanned image is stored while being associated with the type of a document. Selecting an item indicating the type of a document displayed as a preset button in a screen 1000 described below enables performing processing with use of a setting stored in the template without the need to perform individual settings again.

The print instruction unit 425 sends, to the print execution unit 413, a request for print processing corresponding to the print setting input via the UI screen and an image identifier received from the image processing unit 423. The print execution unit 413 receives the print request, including the print setting, and the image identifier sent from the print instruction unit 425. The print execution unit 413 acquires scanned image data corresponding to the image identifier from the internal data storage unit 412 and thus generates image data for printing according to the print request. The print execution unit 413 causes the printer 221 via the printer I/F 216 to print a mask composite image on a recording medium according to the generated image data for printing.

The Internet access unit 426 transmits a processing request to, for example, a cloud service which provides a storage function (storage service). The cloud service is generally a protocol such as Representational State Transfer (REST) or Simple Object Access Protocol (SOAP), in which various interfaces for storing a file in a cloud storage and for acquiring the stored file from an external apparatus have been released to the public. The Internet access unit 426 performs operating a cloud service with use of an interface of the cloud service released to the public. The Internet access unit 426 acquires, from the data management unit 424, a file corresponding to the image identifier received from the image processing unit 423 and transmission information. The Internet access unit 426 transmits, to the external storage 120 via the network I/F 219, the file acquired from the data management unit 424 with use of the transmission information acquired from the data management unit 424.

The display control unit 427 displays a UI screen, which is used for receiving an operation performed by the user, on a liquid crystal display portion having the touch panel function of the operation unit 220 of the MFP 110. For example, the display control unit 427 displays an operation screen used for receiving an operation for scan setting and scan start, a designation operation for preview of a scanned image or a mask region described below, and an operation for preview, output setting, and output start of a mask composite image.

The information detection unit 428 discriminates between character strings received from the image processing unit 423 by types such as “full name” and “e-mail address”, detects character strings falling into a type related to, for example, private information or confidential information, and requests the data management unit 424 to store the detected character strings in the HDD 214. In the first exemplary embodiment, a category for character string, such as “full name” or “e-mail address”, is referred to as a “information classification”. The information classification is a classification of a notion which a character string represents. The information classification is used to designate a character string targeted for masking. While, in the first exemplary embodiment, information classifications which are able to be detected are assumed to be items related to private information or confidential information, such as “full name”, “credit-card number”, and “e-mail address”, the first exemplary embodiment is not limited to this. Information which is able to be acquired as a result of information detection processing performed by the information detection unit 428 is an information classification and a character string corresponding to the information classification. For example, a character string corresponding to the information classification “full name” is “Taro Yamada”. The information detection unit 428 determines an information classification by using machine learning in which, for example, feature quantities of information classifications have been learned with use of, as training data, sample character strings of a plurality of information classifications. Alternatively, the information detection unit 428 previously stores a table in which an information classification and a regular expression of a character string falling into the information classification are associated with each other and detects a character string fitting into the associated regular expression as a character string falling into the corresponding information classification. Alternatively, the information detection unit 428 previously stores an information classification to be detected and detects a character string located near an information classification detected within image data targeted for detection, as a character string falling into the information classification. While, in the first exemplary embodiment, the information detection unit 428 retains items of predetermined detectable information classifications, the location for such retention is not limited to the information detection unit 428. For example, the information detection unit 428 can previously store, for example, the above-mentioned machine learning model or table in the data management unit 424 or the external storage 120 and, when detecting an information classification, acquire such pieces of information from the data management unit 424 or the external storage 120.

The document classification determination unit 429 estimates a document classification based on image processing performed on a scanned image. The document classification is a classification obtained by classifying image data into some types based on the use application of each document, such as “contract”, “shipping slip”, and “bill”. In the first exemplary embodiment, the document classification determination unit 429 determines a document classification using machine learning in which feature quantities of document classifications have been learned with use of, as training data, sample documents of a plurality of document classifications. While, in the first exemplary embodiment, the document classification determination unit 429 uses a transformer-based machine learning model, the first exemplary embodiment is not limited to this. For example, the document classification determination unit 429 can use, for example, a long short-term memory (LSTM) neural network, a sequence-to-sequence model, or a recurrent neural network (RNN). Furthermore, the method of determining a document classification is not limited to this method. For example, the document classification determination unit 429 can previously store a table in which document classifications and layouts of ruled lines or character string blocks of image data have been associated with each other. Then, the document classification determination unit 429 can determine a document classification which is highest in the degree of coincidence between a layout of ruled lines or character string blocks of image data targeted as determination analyzed by the image processing unit 423 and a stored layout, as a classification of the image data. Moreover, the document classification determination unit 429 can previously store a table in which each document classification and a predetermined character string have been associated with each other and then determine a document classification with use of the stored table.

specifically, the document classification determination unit 429 can determine a document classification in which the stored predetermined character string exists in character strings included in image data targeted for determination subjected to character recognition by the image processing unit 423, as a document classification of the image data. The machine learning model or table for determining a document classification can be previously stored in the data management unit 424, or can be previously stored in an external storage and then be acquired from the external storage by the document classification determination unit 429 as needed.

The masking information classification identification processing unit 430 determines an information classification to be subjected to masking, based on the preset, the result of processing performed by the information detection unit 428, and the result of processing performed by the document classification determination unit 429.

### <Flowchart of Overall Processing>

In the processing described below, the CPU 211 of the MFP 110 reads out a control program stored in the ROM 212 or the HDD 214 and executes and controls various functions included in the MFP 110 and functions of an additional application.

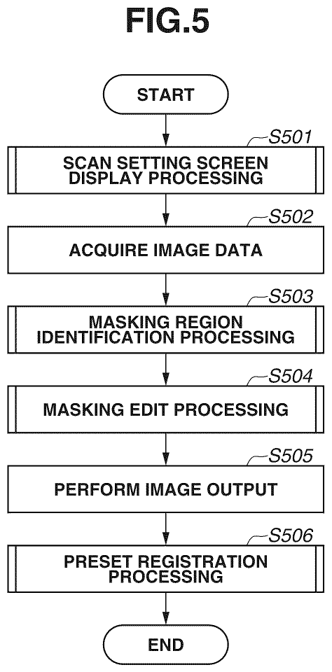

FIG. 5 is a flowchart of processing for generating a mask composite image from an image obtained by scanning performed by the MFP 110 and outputting the generated mask composite image. Examples of outputting of the mask composite image include printing the mask composite image, converting the mask composite image into a file and transmitting the file to a cloud storage (external storage 120), and storing the mask composite image in the internal data storage unit 412 of the MFP 110. Moreover, both printing and transmission of the mask composite image or both printing and storage of the mask composite image can be performed. Furthermore, while, in the first exemplary embodiment, an example in which the display control unit 427 displays a screen on the touch panel of the operation unit 220 is described, a configuration in which the display control unit 427 provides each screen in the first exemplary embodiment to a different apparatus and an operation unit of the different apparatus displays such each screen can be employed.

An additional application for generating a mask composite image obtained by masking a partial region of an image in the first exemplary embodiment (hereinafter referred to as a “masking application”) becomes available by being installed on the MFP 110. The masking application is able to transmit the generated mask composite image to a cloud service, store the generated mask composite image in the MFP 110, or print the generated mask composite image. In response to the masking application being installed on the MFP 110, a button for using the function of the masking application is displayed on a main screen of the MFP 110.

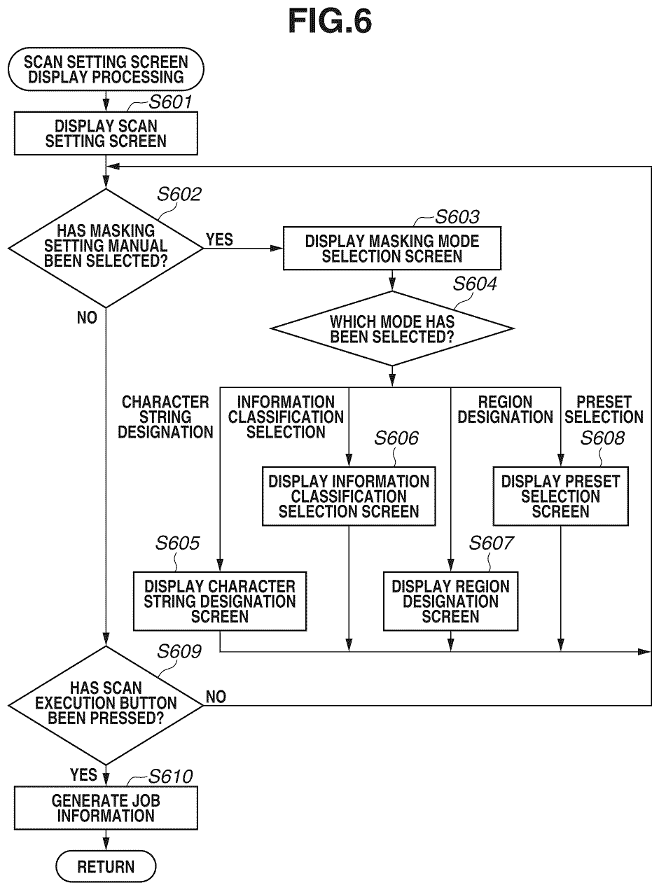

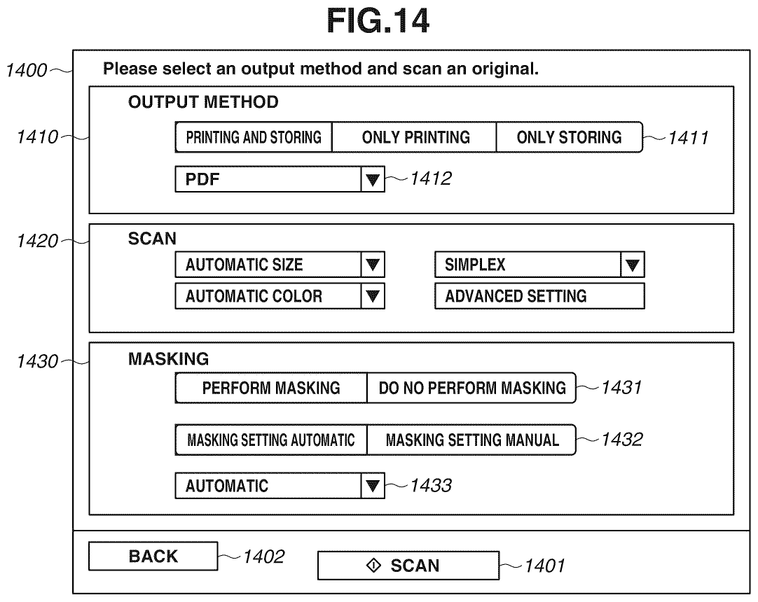

The processing in the present flowchart illustrated in FIG. 5 is started in response to the display control unit 427 detecting a user operation performed on the button for using the function of the masking application. In step S501, the main processing unit 421 requests the display control unit 427 to display a scan setting screen of the masking application, and the display control unit 427 displays a scan setting screen 1400 (illustrated in FIG. 14) on the touch panel of the operation unit 220. Then, in response to receiving a scan execution instruction on the scan setting screen 1400, the main processing unit 421 creates job information based on selections received from the user. The job information includes a masking mode, a masking classification, a masking character string, and a masking region which have been selected by the user. Moreover, any other information can be included in the job information. Details of this operation are described below with reference to FIG. 6.

In step S502, the main processing unit 421 requests the scan execution unit 411 via the scan instruction unit 422 to perform scanning, thus causing the scanner 222 to scan a document to acquire image data and retain the acquired image data in the RAM 213. While, in the first exemplary embodiment, the main processing unit 421 acquires image data by scanning, the first exemplary embodiment is not limited to this. The main processing unit 421 can make a request to the data management unit 424 and acquire image data from the HDD 214 via the internal data storage unit 412. Moreover, the main processing unit 421 can make a request to the data management unit 424 and acquire image data from the external storage 120 via the Internet access unit 426. The main processing unit 421 can acquire image data by using any other method. In the case of acquiring image data by using a method other than scanning, the scan setting screen 1400 is not displayed. For example, before step S501, the display control unit 427 displays a screen (not illustrated) used for the user to select an acquisition method for an image. The display control unit 427 receives, via the displayed screen, any one of selections as to whether to acquire image data by scanning, whether to acquire image data from the HDD 214, and whether to acquire image data from an external storage. In the case of having received the selection of acquiring image data by scanning, the display control unit 427 advances the processing to step S501. In the case of having received the option of acquiring image data from the HDD 214 or the external storage, the display control unit 427 displays not the scan setting screen 1400 but a screen for selecting a file of image data to be acquired. For example, the display control unit 427 displays a folder of the HDD 214 or the external storage and a list of files included in the folder, and receives selection of a file from the user. Then, in step S502, the main processing unit 421 acquires a file the selection of which has been received from the user.

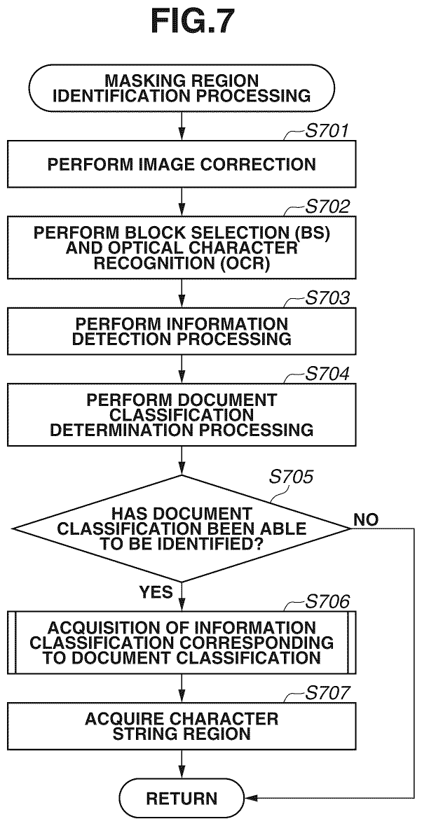

In step S503, the main processing unit 421 requests the image processing unit 423 to generate masking information from the job information acquired in step S501 and the image data acquired in step S502. The image processing unit 423 performs skew rotation correction on the image data acquired in step S502 and thus generates corrected image data. Additionally, the image processing unit 423 analyzes the corrected image data, collates the analyzed image data with the job information acquired in step S501, and thus generates masking information. Details of this operation are described below with reference to FIG. 7.

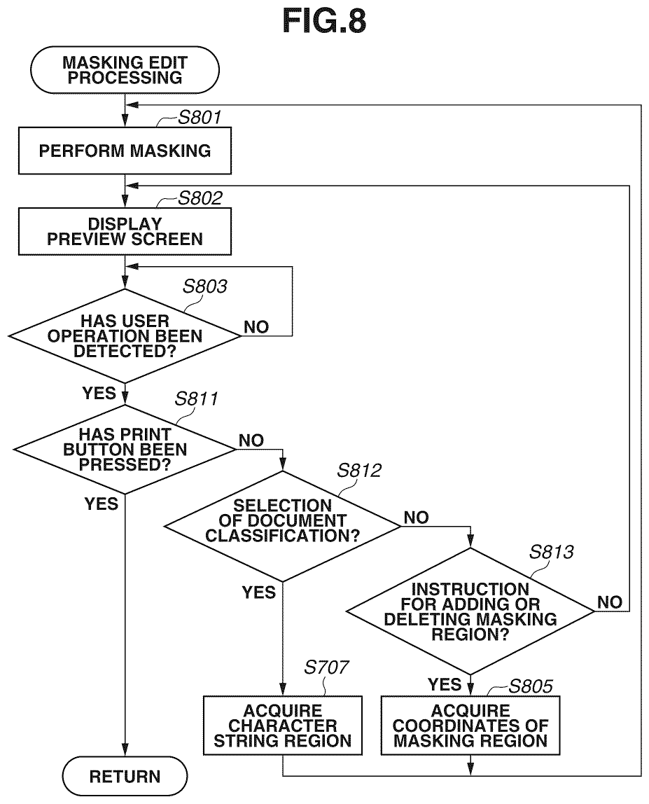

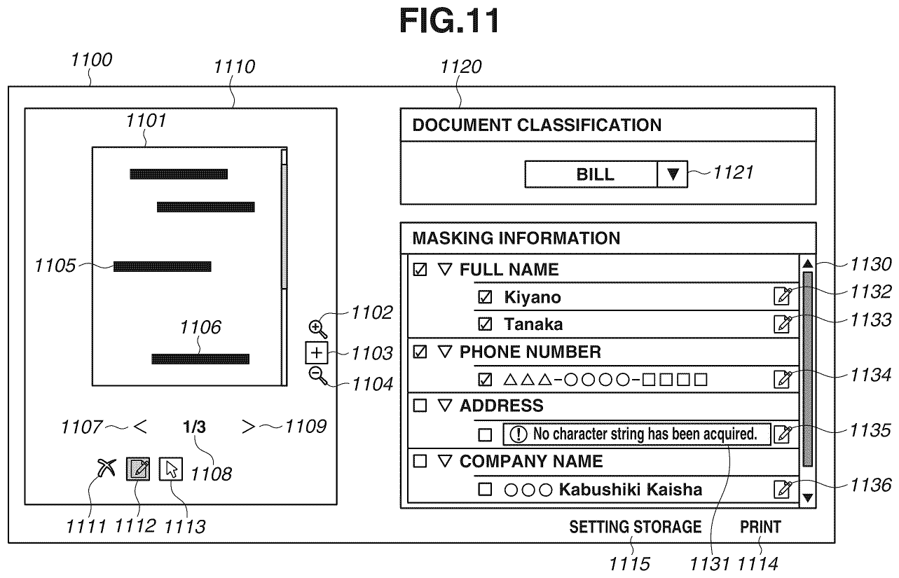

In step S504, the main processing unit 421 requests the image processing unit 423 to create a preview image, in which a mask image is superposed on the corrected image data, from the corrected image data and the masking information generated in step S503. The image processing unit 423 creates the preview image from the corrected image data and the masking information. Next, the main processing unit 421 requests the display control unit 427 to generate and display a preview screen 1100 (illustrated in FIG. 11) which enables viewing the created preview image and correcting the created preview image as needed. The display control unit 427 creates a preview screen, displays the preview screen on the touch panel of the operation unit 220, and performs correction of masking based on the selection received from the user. Details of this operation are described below with reference to FIG. 8.

In step S505, the main processing unit 421 makes a request for creation, printing, storage, or transmission of a mask composite image. Specifically, the MFP 110 creates a mask composite image based on the preview image according to an image output instruction for printing, storage, or transmission issued via the preview screen, and performs image output. The mask composite image is an image obtained by combining a mask image set via the preview screen and the corrected image data with each other, and is an image obtained by composition in such a manner that the mask composite image is unable to be returned to the original corrected image data. In the case of printing, the main processing unit 421 requests the print execution unit 413 via the print instruction unit 425 to print the masking image created in step S504, so that the print execution unit 413 causes the printer 221 to perform printing. In the case of storage, the main processing unit 421 requests the data management unit 424 to store the image in the HDD 214 via the internal data storage unit 412. In the case of transmission, the main processing unit 421 can request the data management unit 424 to store the image in the external storage 120 via the Internet access unit 426 or to perform e-mail transmission of the image to an optional destination. The main processing unit 421 can store the image with use of any other method. The main processing unit 421 determines whether to print the mask composite image or whether to transmit or store the mask composite image, based on the job information created in step S501.

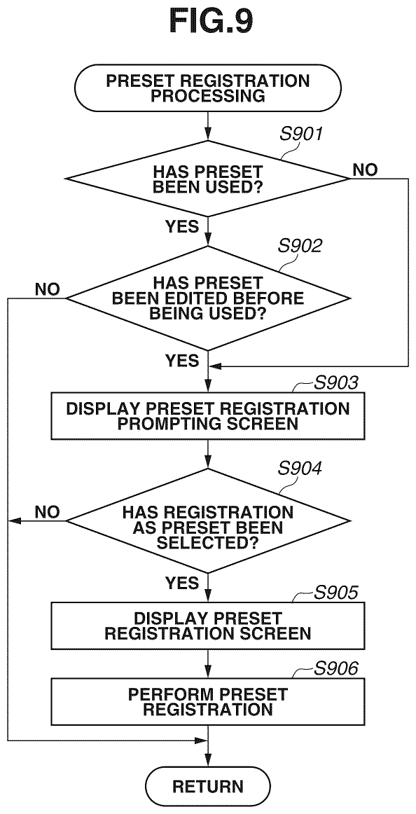

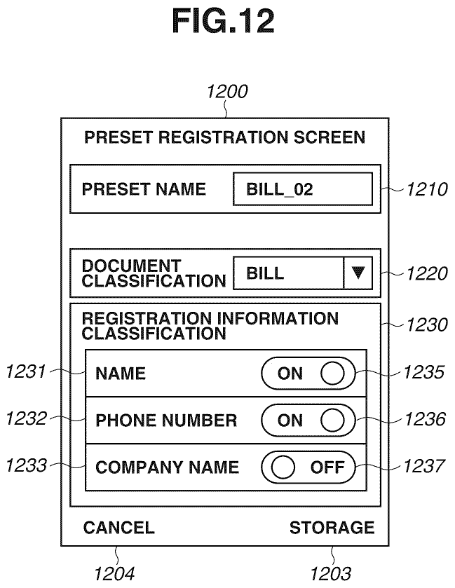

In step S506, the main processing unit 421 requests the display control unit 427 to generate and display a preset registration screen 1200 (illustrated in FIG. 12). The display control unit 427 displays the preset registration screen on the touch panel of the operation unit 220, and registers the preset based on the selection received from the user. Details of this operation are described below with reference to FIG. 9.

FIG. 6 is a flowchart illustrating scan setting screen display processing performed in step S501 in the first exemplary embodiment.

In step S601, the display control unit 427 generates a scan setting screen 1400 in the first exemplary embodiment, and displays the scan setting screen 1400 on the operation unit 220 via the UI display unit 414. FIG. 14 illustrates an example of the scan setting screen 1400. The scan setting screen 1400 is configured with an output method setting area 1410, a scan setting area 1420, a masking setting area 1430, a scan execution button 1401, and a back button 1402. The output method setting area 1410 is configured with an output method selection button 1411 and an output form selection button 1412. The output form selection button 1412 is an item for designating a file type for storage, which is available when the output method selection button 1411 is set to an option “printing and storing” or “only storing”. The output method selection button 1411 is an item for designating an output method for a masked scanned image. The user is allowed to select the output method from among options “only printing”, “only storing”, and “printing and storing”. The scan setting area 1420 is an item for designating scan setting, and is configured to receive a change in setting between options “original size”, “gray/color”, “simplex/duplex”, and “advanced setting”. The option “advanced setting” receives, in a screen (not illustrated), a change in advanced setting for, for example, resolution, image quality, original size mixture, and density. The scan execution button 1401 is a button used to perform scanning using the scan setting set in the scan setting area 1420.

The masking setting area 1430 is configured with a masking selection button 1431, a masking method selection button 1432, and a masking mode selection button 1433. The masking selection button 1431 is a button used to receive selection as to whether to perform masking. The masking method selection button 1432 is a button used to select an execution method for masking in a case where the masking selection button 1431 has been selected. The masking method selection button 1432 allows selecting whether to automatically perform masking setting or whether to manually perform masking setting. Automatically performing masking setting is that the type of a scanned image targeted for editing is automatically determined and a character string falling into an information classification stored while being associated with the determined type is automatically masked. The specific processing thereof is described below. When having detected that automatically performing masking setting has been selected in the masking method selection button 1432, the display control unit 427 sets a mode displayed in the masking mode selection button 1433 to “automatic”.

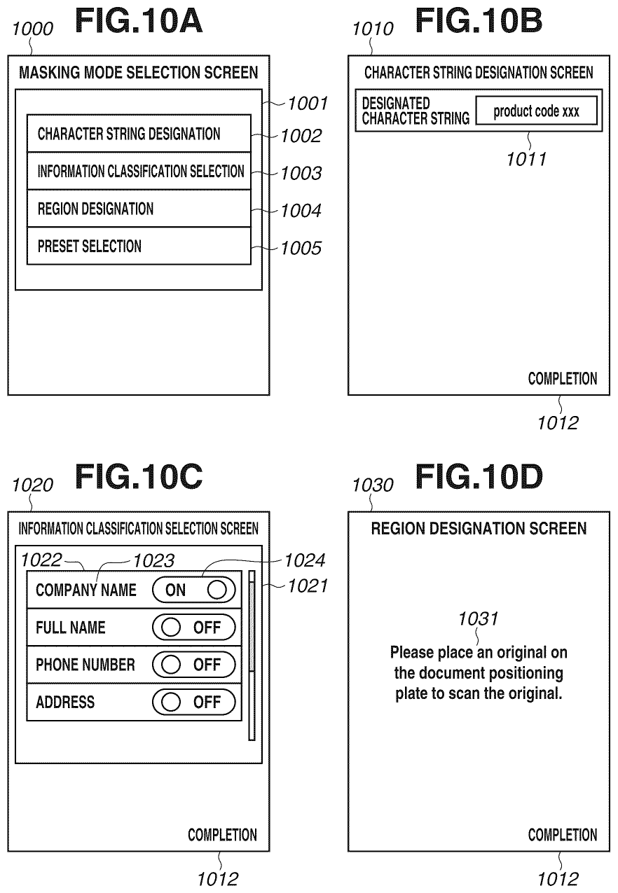

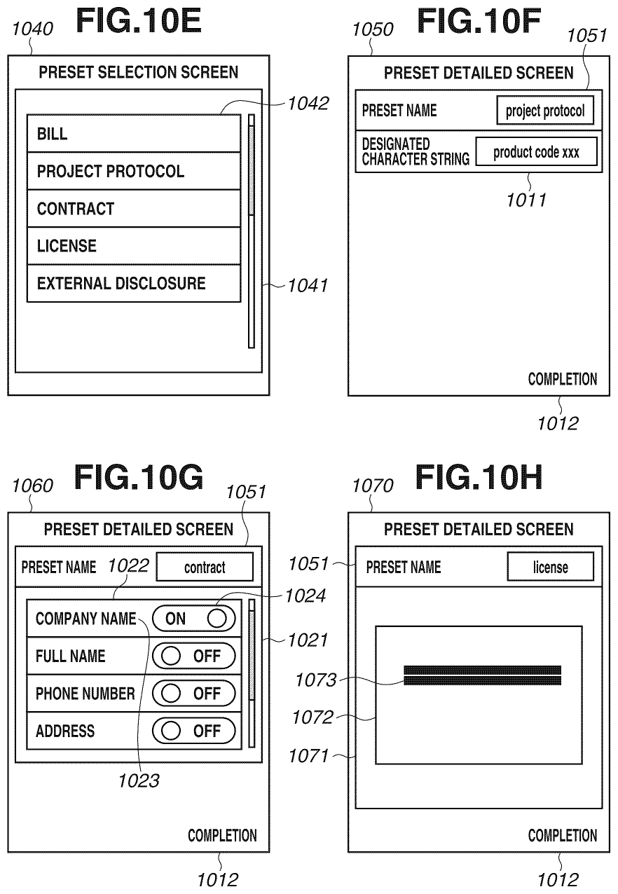

In the first exemplary embodiment, the user is allowed to select manually performing masking setting using the masking method selection button 1432. In step S602, the display control unit 427 determines whether the option “masking setting manual” has been selected in the masking method selection button 1432. If it is determined that the option “masking setting manual” has been selected in the masking method selection button 1432 (YES in step S602), then in step S603, the display control unit 427 performs pop-up displaying of a masking mode selection screen 1000 illustrated in FIG. 10A and receives selection of a masking mode. Specifically, the display control unit 427 performs pop-up displaying of the masking mode selection screen 1000 on the scan setting screen 1400 displayed on the operation unit 220. Here, the masking mode is the type of a designation method for a masking region to be performed in the first exemplary embodiment, and includes automatic, character string designation, information classification selection, region designation, and preset selection. The character string designation is a mode which performs masking of a character string selected by the user from among character strings recognized in a scanned image. The information classification selection is a mode which performs masking of a character string falling into an information classification selected by the user from among character strings recognized in a scanned image. The region designation is a mode which performs masking of a rectangular region designated by the user in a preview screen. The preset selection is a mode which preliminarily prepares presets each with a masking region designated, allows the user to select one preset from among the prepared presets, and performs masking according to the content of the selected preset. The designation method for a masking region includes at least one of methods including character string designation, information classification selection, and region designation. The masking mode selection screen 1000 is configured with a masking mode list 1001. In the first exemplary embodiment, the masking mode list 1001 is configured with a character string designation button 1002, an information classification selection button 1003, a region designation button 1004, and a preset selection button 1005, but can be further include any other button.

In step S604, the display control unit 427 determines which mode has been selected by the user. Then, in step S605 to step S608, the display control unit 427 causes the masking mode selection screen 1000, which has been displayed as a pop-up, to transition to a detailed screen corresponding to the selected masking mode. Upon completion of operations in the detailed screen, the display control unit 427 closes the pop-up, and displays the selected mode on the masking mode selection button 1433 in the scan setting screen 1400. Furthermore, in the first exemplary embodiment, the display control unit 427 performs pop-up displaying, but can transition to another screen or can display all of the items in a pull-down menu and receive selection.

Processing operations in step S604 to step S608 are specifically described. In step S604, when having detected pressing of the character string designation button 1002, the display control unit 427 determines that “character string designation” has been selected and then advances the processing to step S605 to perform screen transition. In a case where the masking mode is character string designation, the display control unit 427 performs masking of a region of the selected character string from among character strings detected by optical character recognition (OCR) processing in step S702 described below. In step S605, the display control unit 427 generates a character string designation screen 1010 illustrated in FIG. 10B, and causes pop-up displaying on the scan setting screen 1400 of the operation unit 220 to transition from the masking mode selection screen 1000 to the character string designation screen 1010. The character string designation screen 1010 is configured with a character string input form 1011 and a completion button 1012. Moreover, the character string designation screen 1010 can be configured to further include any other method. The character string input form 1011 is a form to which to input a character string targeted for masking. For example, in the case of masking a character string “product code xxx”, the character string input form 1011 receives inputting of the character string performed by the user. In response to the completion button 1012 being pressed in the character string designation screen 1010, the display control unit 427 then retains information set in the character string designation screen 1010 in the RAM 213. For example, in a case where “product code xxx” is currently input to the character string input form 1011, the display control unit 427 stores “character string designation” as the masking mode, “designated character string” as the masking classification, and “product code xxx” as the masking character string. Furthermore, since, at the time of character string designation, the coordinates of a masking region are not determined, the display control unit 427 stores information about the masking region as nil. Then, the display control unit 427 closes the pop-up and returns the processing to step S602.

Moreover, in step S604, when having detected pressing of the information classification selection button 1003, the display control unit 427 determines that “information classification selection” has been selected and then advances the processing to step S606 to perform screen transition. In a case where the masking mode is information classification selection, the display control unit 427 performs information detection in the flowchart of FIG. 7 described below, and performs masking of a character string region corresponding to the information classification concerned. In step S606, the display control unit 427 acquires a list of predetermined detectable information classifications from the information detection unit 428 and generates an information classification selection screen 1020 illustrated in FIG. 10C. Next, the display control unit 427 causes pop-up displaying on the scan setting screen 1400 of the operation unit 220 to transition from the masking mode selection screen 1000 to the information classification selection screen 1020. The information classification selection screen 1020 is configured with an information classification list 1021 and a completion button 1012. Moreover, the information classification selection screen 1020 can include any other constituent element. The information classification list 1021 is an area in which to display, in list form, information classification items 1022, the number of which is equal to the number of detectable information classifications. For example, in a case where the detectable information classifications are “company name, full name, phone number, and address”, information classification items 1022 for “company name, full name, phone number, and address” are displayed in the information classification list 1021. In a case where not all of the information classification items 1022 fit into a display area of the information classification list 1021, a configuration in which a scroll bar is displayed to enable performing scroll display can be employed. Each of the information classification items 1022 is configured with an information classification name 1023 and a toggle button 1024. The information classification name 1023 is an area for displaying the name of an information classification. The toggle button 1024 is a button which is switched to be turned on at the time of setting an information classification displayed with the information classification name 1023 as a masking target and is switched to be turned off at the time of not wanting to set the information classification as a masking target. For example, at the time of setting an information classification “company name” as a masking target, in response to pressing performed by the user, a toggle button corresponding to the information classification “company name” is switched to be turned on. In this way, the information classification selection screen 1020 is a screen used to receive a detectable information classification to be set as a masking target. In response to the completion button 1012 being pressed in the information classification selection screen 1020, the display control unit 427 then retains information set by the information classification selection screen 1020 in the RAM 213. Specifically, the display control unit 427 stores “information classification selection” as the masking mode and stores, as the masking classification, all of the information classifications the toggle button 1024 for each of which is in an on-state in the information classification list 1021. For example, in a case where the toggle button for the information classification “company name” is in an on-state in the information classification list 1021, the display control unit 427 stores the information classification “company name” as the masking classification. Furthermore, since, at the time of information classification selection, a character string to be masked and the coordinates of a masking region are not determined, the display control unit 427 stores information about the character string and the masking region as nil. Then, the display control unit 427 closes the pop-up and returns the processing to step S602.

Moreover, in step S604, when having detected pressing of the region designation button 1004, the display control unit 427 determines that “region designation” has been selected and then advances the processing to step S607 to perform screen transition. In a case where the masking mode is region designation, the display control unit 427 performs acquisition of the coordinates of a rectangular region in the flowchart of FIG. 8 described below, and performs masking of a rectangular region selected in response to pressing performed by the user. In step S607, the display control unit 427 generates a region designation screen 1030 illustrated in FIG. 10D, and performs pop-up displaying of the region designation screen 1030 on the scan setting screen 1400 of the operation unit 220. The region designation screen 1030 is configured with a message 1031 and a completion button 1012. Moreover, the region designation screen 1030 can further include any other constituent element. The message 1031 is a region in which to display a message for prompting the user to perform scanning. In response to the completion button 1012 being pressed in the region designation screen 1030, the display control unit 427 stores “region designation” as the masking mode in the RAM 213, closes the pop-up, and then returns the processing to step S602. Furthermore, since, in region designation, a region to be actually masked is designated by the user after acquisition of image data, the masking classification, masking region, and masking character string are not yet determined in step S607. Therefore, information about the masking classification, masking region, and masking character string is stored as nil.

Moreover, in step S604, when having detected pressing of the preset selection button 1005, the display control unit 427 determines that “preset selection” has been selected and then advances the processing to step S608 to perform screen transition. In a case where the masking mode is preset selection, in the flowchart of FIG. 7 described below, the display control unit 427 determines a masking region according to the content of the selected preset, and performs masking. In step S608, the display control unit 427 requests the data management unit 424 to acquire a list of presets already registered. The data management unit 424 acquires the list of presets from the HDD 214 via the internal data storage unit 412, and passes the acquired list of presets to the display control unit 427. Moreover, the data management unit 424 can acquire the list of presets from the external storage 120 via the Internet access unit 426, or can acquire the list of presets using any other method. The display control unit 427 extracts respective presets from the acquired list of presets, generates a preset selection screen 1040 illustrated in FIG. 10E, and performs pop-up displaying of the preset selection screen 1040 on the scan setting screen 1400 of the operation unit 220. The preset selection screen 1040 is a screen for displaying a list of presets in list form and receiving selection of an optional preset. The preset selection screen 1040 is configured with a preset list 1041. The preset list 1041 is an area in which to display preset buttons 1042 the number of which is equal to the number of presets included in the list of presets. For example, in a case where the list of presets includes presets “bill, project protocol, contract, license, and external disclosure”, preset buttons for “bill, project protocol, contract, license, and external disclosure” are displayed in the preset list 1041. In a case where not all of the preset buttons 1042 fit into a display area of the preset list 1041, a configuration in which a scroll bar is displayed to enable performing scroll display can be employed. Each of the preset buttons 1042 is a button used to select a preset. Each of the preset buttons 1042 displays the name of a preset.

In response to any one of preset buttons included in the preset list 1041 being pressed by the user, the display control unit 427 generates a preset detailed screen 1050, 1060, or 1070 illustrated in FIG. 10F, 10G, or 10H according to the content of the preset concerned. Next, the display control unit 427 performs pop-up displaying of the preset detailed screen 1050, 1060, or 1070 on the scan setting screen 1400 of the operation unit 220. The preset detailed screen is a screen used to display the content of the selected preset. For example, in a case where the preset “contract” has been selected, a preset detailed screen for displaying the content of the preset “contract” is generated.

In a case where the content of the selected preset is a masking character string, the display control unit 427 displays the preset detailed screen 1050 for character string designation illustrated in FIG. 10F. In a case where the content of the selected preset is a masking classification, the display control unit 427 displays the preset detailed screen 1060 for information classification selection illustrated in FIG. 10G. In a case where the content of the selected preset is a masking region, the display control unit 427 displays the preset detailed screen 1070 for region designation illustrated in FIG. 10H. Moreover, in a case where the content of the selected preset is a composite content including a masking character strung, a masking classification, and a masking region, the display control unit 427 performs displaying in such a way as to switch between the respective preset detailed screens.

The preset detailed screen 1050 is configured with a preset name 1051, a character string input form 1011, and a completion button 1012. The preset name 1051 displays the name of the preset concerned. A masking character string for the preset concerned is input to the character string input form 1011 by default. Moreover, in the character string input form 1011, a masking character string can be freely edited in response to an input from the user. In response to the completion button 1012 being pressed in the preset detailed screen 1050, the display control unit 427 retains the settings input in the preset detailed screen 1050 in the RAM 213, closes the pop-up, and then returns the processing to step S602.

The preset detailed screen 1060 is configured with a preset name 1051, an information classification list 1021, and a completion button 1012. An information classification item 1022 which falls into the masking classification of the preset concerned in the information classification list 1021 has a toggle button switched to an on-state by default. An information classification item 1022 which does not fall into the masking classification of the preset concerned in the information classification list 1021 has a toggle button switched to an off-state by default. Moreover, in response to pressing performed by the user, the toggle button can be freely edited. In response to the completion button 1012 being pressed in the preset detailed screen 1060, the display control unit 427 retains the settings input in the preset detailed screen 1060 in the RAM 213. Specifically, the display control unit 427 stores, as masking classifications, all of the information classifications the toggle button 1024 for each of which is in an on-state in the information classification list 1021. Then, the display control unit 427 closes the pop-up, and returns the processing to step S602.

The preset detailed screen 1070 is configured with a preset name 1051, a preset preview 1071, and a completion button 1012. The preset preview 1071 is configured with an image outline preview 1072 and a masking region 1073. The image outline preview 1072 displays the outline of an image from an image size included in the preset. The masking region 1073 displays a region to be masked within the same coordinate position on the image outline preview 1072 from masking regions included in the preset. The preset preview 1071 displays a region to be masked within an image by displaying the image outline preview 1072 and the masking region 1073. In response to the completion button 1012 being pressed in the preset detailed screen 1070, the display control unit 427 retains the masking region of the preset concerned set in the preset detailed screen 1070 in the RAM 213. For example, in a case where the masking region of the preset is “(441, 957), (1369, 1057)”, the display control unit 427 stores “rectangular region” as the masking classification and stores “(441, 957), (1369, 1057)” as the masking region. Then, the display control unit 427 closes the pop-up, and then returns the processing to step S602.

In a case where the content of the preset is a composite content and the preset detailed screen is displayed after being switched, in response to the completion button 1012 being pressed, the display control unit 427 generates job information, and adds the masking mode determined in step S603 to the job information. Next, the display control unit 427 retains the contents set in all of the preset detailed screens in the RAM 213, closes the pop-up displaying, and returns the processing to step S602.

In step S609, the display control unit 427 determines whether the scan execution button 1401 has been pressed. When having detected pressing of the scan execution button 1401 (YES in step S609), the display control unit 427 advances the processing to step S610, in which the display control unit 427 generates job information. Specifically, the display control unit 427 generates job information based on information set on the scan setting screen 1400 and information set in steps S605 to S608 and retained in the RAM 213. The job information includes information about the masking mode, masking character string, masking information classification, and masking region selected by the user.

FIG. 7 is a flowchart illustrating masking region identification processing in step S503 in the first exemplary embodiment. The flowchart of FIG. 7 illustrates processing which is performed in a case where, in step S501, the masking mode has been set to “automatic”. In a case where the masking mode has been set to “character string designation”, “information classification selection”, “region designation”, or “preset selection”, some processing operations are omitted. For example, in a case where “character string designation” is selected as the masking mode and the masking classification included in the job information is nil, i.e., in a case where, after acquisition of image data, the user manually designates the coordinates of a masking region, steps S702, S703, and S704 can be skipped. Moreover, in a case where the masking mode is “preset selection” and the masking classification included in the job information is only a rectangular region, steps S702 and S703 can be skipped. Whether to omit some processing operations is determined based on job information which the main processing unit 421 has generated in step S501.

In step S701, the image processing unit 423 performs skew correction or rotation correction on image data acquired in step S502, and retains the corrected image data in the RAM 213.

In step S702, the image processing unit 423 converts the corrected image data into a one-channel image to improve the accuracy of optical character recognition (OCR), performs OCR on the one-channel image, and retains the extracted one or more character strings and one or more character string regions corresponding to the one or more character strings in the RAM 213. Specifically, the image processing unit 423 stores the character string and the coordinates indicating the position of the character string region in the RAM 213 while associating them with each other. The character string region corresponding to the character string is a rectangle circumscribing the character string.

In step S703, the information detection unit 428 performs information detection processing from the character string extracted in step S702, and retains an information classification detectable by the information detection unit 428 and a character string corresponding to the detected information classification in the RAM 213. An example of a result of the information detection processing in the first exemplary embodiment is shown in an information detection processing result information list written in Table 1. In the information detection processing result information list, the information classifications are “company name”, “full name”, “phone number”, and “address”. The character strings corresponding to the detected information classifications are “∘∘∘ Kabushiki Kaisha” as a character string corresponding to the company name, “Kiyano” and “Tanaka” as character strings corresponding to the full name, and “xxx-∘∘∘∘-□□□□” as a character string corresponding to the phone number. “- (none)” in Table 1 indicates that a character string corresponding to the address has not been detected. Furthermore, while, in the first exemplary embodiment, the information classifications detectable by the information detection unit 428 are four classifications, i.e., “company name”, “full name”, “phone number”, and “address”, another character string can be configured to be detectable. For example, further detectable information classifications include “credit-card number”, “e-mail address”, and “date and time”. Furthermore, instead of an information detection unit included in the MFP 110, an external apparatus or an external cloud service can be configured to perform similar information detection. Then, the information detection unit 428 can be configured to, in step S703, acquire information classifications and character strings which have been detected by such an external unit.

TABLE 1
Information Detection Processing Result Information List

| Information | Character string corresponding to information |
|---|---|
| classification | classification |
| Company name | ∘∘∘ Kabushiki Kaisha |
| Full name | Kiyano |
| Full name | Tanaka |
| Phone number | xxx-∘∘∘∘-□□□□ |
| Address | — (none) |

In step S704, the document classification determination unit 429 performs recognition processing for identifying a document classification. For example, the document classification determination unit 429 identifies a document classification from character strings extracted in step S702. While, in the first exemplary embodiment, a preliminarily trained machine learning model is used to perform determination of a document classification, preliminarily setting keywords corresponding to respective document classifications can be used to determine a document classification. Alternatively, without using character strings extracted in step S702, a document classification can be determined based on ruled lines of image data or a layout that is based on, for example, character string blocks.

In step S705, the masking information classification identification processing unit 430 determines whether a document classification has been able to be identified in step S704. If it is determined that a document classification has been able to be identified (YES in step S705), the masking information classification identification processing unit 430 advances the processing to step S706, and, if it is determined that a document classification has not been able to be identified (NO in step S705), the masking information classification identification processing unit 430 ends the processing in the present flowchart.

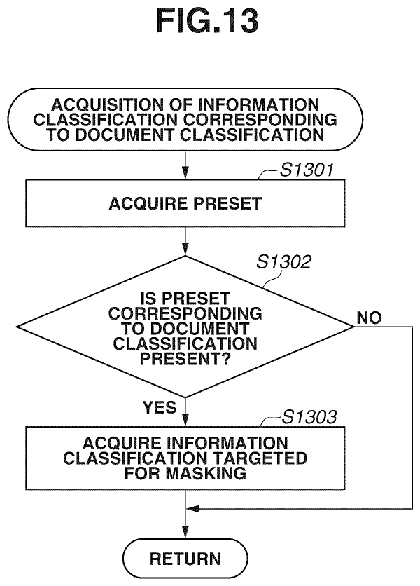

In step S706, the masking information classification identification processing unit 430 requests the data management unit 424 to acquire a preset corresponding to the determined and acquired document classification, and retains an information classification targeted for masking included in the acquired preset in the RAM 213. The preset can be acquired from the HDD 214, or can be acquired from the external storage 120. Details of this operation are described below with reference to FIG. 13.

FIG. 13 is a flowchart illustrating processing for acquiring an information classification corresponding to a document classification, which is performed in step S706 in the first exemplary embodiment.

In step S1301, the masking information classification identification processing unit 430 acquires a preset corresponding to a document classification from, for example, the external storage 120 via the Internet access unit 426, and retains the acquired preset in the RAM 213. Here, the term “preset” means a thing which retains an information classification which is often targeted for masking for each document classification while associating the information classification with the document classification. A separately prepared registration screen can be used for the user to preliminarily register an information classification and a document classification, or a preset registration screen (described below) prepared after outputting of a mask composite image can be used to set an information classification and a document classification.

Examples of presets which are stored in the external storage 120 or the HDD 214 are shown in a preset information list written in Table 2. As shown in Table 2, information classifications differing for respective document classifications are stored in association with each other. In this way, preliminarily preparing presets for each of a plurality of document classifications enables automatically performing masking processing for an information classification corresponding to a document classification.

TABLE 2
Preset Information List

| | Information classification targeted |
|---|---|
| Document classification | for masking |
| Bill | Full name, phone number, address |
| Project protocol | Company name, full name, date |
| Contract | Company name, full name, phone number, |
| | address |
| License | Full name, address, date of birth |
| External disclosure | Company name, full name, phone number |

In step S1302, the masking information classification identification processing unit 430 determines whether a preset corresponding to the document classification determined in step S704 is present in the acquired presets for respective document classifications. If it is determined that the preset is present (YES in step S1302), the masking information classification identification processing unit 430 advances the processing to step S1303, and, if it is determined that the preset is not present (NO in step S1302), the masking information classification identification processing unit 430 determines that there is no information classification targeted for masking, and then ends the processing in the present flowchart.

In step S1303, the masking information classification identification processing unit 430 extracts, from information about the presets acquired in step S1301, information about an information classification targeted for masking which is associated with a preset corresponding to the document classification determined in step S704, retains the extracted information in the RAM 213, and then ends the processing in the present flowchart.

For example, in a case where, in step S704, it is determined that the document classification is “bill”, the information classifications targeted for masking are “full name”, “phone number”, and “address”. Moreover, in a case where, in step S704, it is determined that the document classification is “project protocol”, the information classifications targeted for masking are “company name”, “full name”, and “date”.

In step S707, the image processing unit 423 compares the information classifications detected in step S703 and the information classifications acquired in step S706 with each other, and identifies the coincident information classification. Then, the image processing unit 423 determines, as a masking region, the character string region of a character string corresponding to the coincident information classification from among the information classifications detected in step S703. Then, the image processing unit 423 stores the masking information and the document classification in the RAM 213. The masking information is configured with an information classification serving as an information detection processing result, a character string corresponding to the information classification, the necessity or unnecessity of masking indicating whether the information classification concerned is an information classification targeted for masking acquired in step S706, and the position (coordinates) of a masking region.

An example of the masking information in the first exemplary embodiment is shown in a masking information list written in Table 3. Table 3 shows a masking information list obtained in a case where, in step S704, it is determined that the document classification is “bill”. The information classifications targeted for masking, “full name”, “phone number”, and “address” are set to “necessity” in the necessity or unnecessity of masking. Then, the information detection unit 428 searches for character strings the information classifications of which are “full name”, “phone number”, and “address” from among a plurality of character strings included in image data targeted for editing obtained by OCR processing in step S702. Specifically, the information detection unit 428 performs searches using the information detection processing result detected in step S703. The information detection unit 428 searches for character strings detected as character strings corresponding to “full name”, “phone number”, and “address” in the information detection processing. Thus, the information detection unit 428 searches for “Kiyano”, “Tanaka”, and “xxx-∘∘∘∘-□□□□”. Then, the information detection unit 428 identifies the coordinates of the area of each of the searched-for character strings based on the association between a character string and a character string region obtained by OCR processing in step S702. The positions of regions included in the masking information list are character string regions of character strings corresponding to the information classifications “company name”, “full name”, and “phone number”, respectively. Since a character string corresponding to “address” has not been detected and is set to “- (none)”, the character string region of the character string corresponding to “address” is not identified, and the position of the character string region is also not able to be acquired. In a case where, in step S704, it is determined that the document classification is “project protocol”, the information classifications “company name” and “full name” targeted for masking in the information classifications detected in step S703 are set to “necessity” in the necessity or unnecessity of masking.

TABLE 3
Masking Information List

| | Character string | | Position of region |
|---|---|---|---|
| | corresponding to | Necessity or | (coordinates of |
| Information | information | unnecessity | starting point |
| classification | classification | of masking | and ending point) |
| Company name | ∘∘∘ Kabushiki | unnecessity | (141, 161), |
| | Kaisha | | (397, 345) |
| Full name | Kiyano | necessity | (341, 461), |
| | | | (997, 545) |
| Full name | Tanaka | necessity | (510, 461), |
| | | | (1166, 545) |
| Phone number | xxx-∘∘∘∘-□□□□ | necessity | (441, 557), |
| | | | (1369, 653) |
| Address | — (none) | necessity | — (none) |

FIG. 8 is a flowchart illustrating masking edit processing in step S504 in the first exemplary embodiment.

In step S801, the image processing unit 423 acquires, from the RAM 213, the corrected image data acquired in step S701 and the masking information generated in step S707 or step S805. The image processing unit 423 acquires the position (starting point and ending point coordinates) of a region the necessity or unnecessity of masking of which is necessity in the acquired masking information, and generates a preview image obtained by superposing a mask image on a rectangular region identified by the acquired coordinate position on the corrected image data. The image processing unit 423 retains the generated preview image in the RAM 213. Data representing the preview image generated here is data obtained by superposing a mask image on the original corrected image data acquired in step S701, and includes data about a region masked on the corrected image data. Thus, the preview image data is generated in such a way as to be able to be returned to the original corrected image data by canceling the mask image on a preview screen described below.

In step S802, the display control unit 427 acquires the preview image generated in step S801 from the RAM 213 to generate a preview screen 1100 illustrated in FIG. 11, and displays the preview screen 1100 on the touch panel via the UI display unit 414. The preview screen 1100 indicates an example of displaying of a preview image in the first exemplary embodiment. The preview screen 1100 is configured with an image display area 1110, a document classification display area 1120, a masking information display area 1130, a print button 1114, which is used to finalize masking processing with a preview image in the process of preview displaying and issue an instruction for printing, and a setting storage button 1115. Details of the setting storage button 1115 are described below with reference to FIG. 9.

The image display area 1110 is configured with elements 1101 to 1109 and elements 1111 to 1113. The preview image display area 1101 is an area in which to display a preview image generated in step S801. In a case where not the entire preview image fits into the preview image display area 1101, a scroll bar is automatically displayed. The preview display enlargement button 1102 and the preview display reduction button 1104 are buttons used for the user to perform enlargement or reduction display designation of a preview image displayed in the preview image display area 1101. The elements 1105 and 1106 are mask images. The preview display fit button 1103 is a button for receiving, from the user, an instruction for determining the enlargement or reduction rate of the preview image in such a manner that the preview image just fits into the preview image display area 1101 and performing displaying of the preview image. The page count indication 1108 is an indication representing a page count of the preview image being displayed in the preview image display area 1101. The previous page button 1107 is a button for receiving, from the user, an instruction for displaying a preview image on the previous page. The next page button 1109 is a button for receiving, from the user, an instruction for displaying a preview image on the next page. The masking deletion button 1111 is a button for receiving, from the user, an instruction for deleting a mask image. The masking instruction button 1112 is a button used for the user to issue an instruction for setting a masking region on the preview image. The masking selection button 1113 is a button used for the user to issue an instruction for selecting a mask image.

The preview display enlargement button 1102 is a button for increasing the display magnification of a preview image displayed in the preview image display area 1101 by a given amount and thus performing enlarged displaying of the preview image.

The preview display fit button 1103 is a button for changing the display magnification of a preview image to the maximum magnification with which the preview image fits into the preview image display area 1101. The preview display reduction button 1104 is a button for decreasing the display magnification of a preview image displayed in the preview image display area 1101 by a given amount and thus performing reduced displaying of the preview image.

The previous page button 1107 is a button for displaying a scanned image on the previous page in a case where there are scanned images for a plurality of pages. The page count indication 1108 indicates a page number of a scanned image being currently displayed and the total number of pages. The next page button 1109 is a button for displaying a scanned image on the next page in a case where there are scanned images for a plurality of pages.

The masking deletion button 1111 is a button for deleting a mask image currently selected in the preview image display area 1101. When detecting that a mask image being displayed as a masking target with the masking selection button 1113 selected has been touched by a finger on the preview image, the display control unit 427 recognizes that the touched mask image is a mask image selected for a next operation. Then, when detecting pressing of the masking deletion button 1111 following the selection of the mask image, the display control unit 427 sets the necessity or unnecessity of masking for the masking information to “unnecessity” with respect to a masking region corresponding to the selected mask image. The image processing unit 423 generates a preview image based on the updated masking information and thus updates the preview image display area 1101.

In a case where the masking instruction button 1112 is currently selected, the display control unit 427 detects a portion touched by the finger on the preview image as a starting point. Thus, when detecting a user operation, the display control unit 427 acquires coordinate information in the preview image at the detected portion.

Next, the display control unit 427 detects an ending point from which the finger moves away after the drag operation. Thus, when detecting that the finger of the user has moved away from the panel, the display control unit 427 acquires coordinate information in the preview image at the detected portion from which the finger has moved away. Then, the display control unit 427 recognizes a rectangular region designated by the coordinates of the starting point and the coordinates of the ending point as a masking region. Then, the display control unit 427 superposes the mask image on the recognized masking region to update the preview image.

The document classification display area 1120 is configured with a document classification selection drop-down list 1121, and displays a document classification determination result obtained in step S704. The document classification selection drop-down list 1121 is used to receive selection of a document classification performed by the user. In a case where the document classification determination result has not been able to be acquired, the document classification display area 1120 displays a blank indicating that the document classification is “not set” (not illustrated).

The masking information display area 1130 is an area for displaying information about masking which is currently displayed in the preview image display area 1101. On a preview screen which is first displayed in step S802 after execution of scanning, the display control unit 427 displays masking information corresponding to the document classification currently displayed in the document classification display area 1120 in the masking information display area 1130. In a case where no document classification is set in the document classification display area 1120, since masking information is not present, the masking information display area 1130 does not display masking information. In a case where the document classification selection drop-down list 1121 is operated by the user to designate a document classification, the masking information classification identification processing unit 430 acquires information classifications corresponding to the document classification (performs a processing operation similar to that in step S706), and thus generates masking information. The masking information display area 1130 displays the information classifications and character strings corresponding to the information classifications detected in step S703 in tree structure. The masking information display area 1130 performs displaying in such a manner that the parent is an information classification and the child is a character string corresponding to the information classification. Thus, with respect to each of a plurality of information classifications, the masking information display area 1130 displays one or more character strings corresponding to respective information classifications while associating the information classifications and the character strings with each other.

Additionally, with respect to each information classification and each character string corresponding to the information classification, the masking information display area 1130 has a checkbox which is used to receive the necessity or unnecessity of masking by a tap operation. The display control unit 427 sets the necessity or unnecessity of masking to “necessity” when the checkbox has been selected and sets the necessity or unnecessity of masking to “unnecessity” when the checkbox has been unselected. The display control unit 427 receives, from the user via the checkbox, a designation for selecting or unselecting each information classification or each character string corresponding to the information classification. In the first exemplary embodiment, the display control unit 427 displays checkboxes of information classifications and character strings corresponding to the information classifications in each of which the necessity or unnecessity of masking is “necessity” and the position of a region exists based on masking information, in the state of being preliminarily selected with check marks. In a case where a checkbox has been pressed, the display control unit 427 changes the necessity or unnecessity of masking of the masking information concerned. In a case where a checkbox has been pressed when the necessity or unnecessity of masking is “necessity”, the display control unit 427 changes the necessity or unnecessity of masking to “unnecessity”, and, in a case where a checkbox has been pressed when the necessity or unnecessity of masking is “unnecessity”, the display control unit 427 changes the necessity or unnecessity of masking to “necessity”.

For example, in response to a checkbox for the information classification “full name” being pressed with the information classification “full name” being selected as illustrated in FIG. 11, the display control unit 427 receives an instruction for unselecting the information classification “full name”. Then, the display control unit 427 changes the necessity or unnecessity of masking corresponding to the information classification “full name” from “necessity” to “unnecessity” in the masking information. Then, the display control unit 427 displays, without masking, a character string corresponding to “full name” in the preview image display area 1101 displayed on the image display area 1110. Thus, the display control unit 427 deletes mask images which have been displayed in superposition on character strings “Kiyano” and “Tanaka” corresponding to “full name”. Moreover, in response to a checkbox for the information classification “company name” being pressed with the information classification “company name” being not selected as illustrated in FIG. 11, the display control unit 427 receives an instruction for selecting the information classification “company name”. Then, the display control unit 427 changes the necessity or unnecessity of masking corresponding to the information classification “company name” from “unnecessity” to “necessity” in the masking information. Then, the display control unit 427 perform displaying while masking a character string corresponding to “company name” in the preview image display area 1101 displayed on the image display area 1110. Thus, the display control unit 427 displays a mask image in such a way as to be superposed on a character string “∘∘∘ Kabushiki Kaisha” corresponding to “company name”.

Moreover, while the display control unit 427 performs displaying in such a manner that an information classification the necessity or unnecessity of masking for which becomes “necessity” is located at the higher level to improve visibility, the sequential order of displaying is not limited to this. Additionally, the display control unit 427 displays an information classification the necessity or unnecessity of masking for which is “unnecessity” based on the masking information, with a checkbox therefor being unselected. Since, although an information classification the necessity or unnecessity of masking for which is “unnecessity” is not included in a preset, an information classification detected by the information detection processing is personal information or confidential information and masking processing is likely to be performed depending on users, the display control unit 427 performs such displaying in order to provide a presentation to the user.

A warning mark 1131 is an indication for giving a warning to the user with respect to an item in which, although the necessity or unnecessity of masking is “necessity”, the position of a region does not exist. A region position edit button is able to be used to set the position of a region to masking information. Each of region position edit buttons 1132, 1133, 1134, 1135, and 1136 is a button used to edit the position of a region. As with the masking instruction button 1112, each region position edit button is used to receive a rectangular region and update masking information with the rectangular region in association with an item corresponding thereto. In the masking information list, with regard to the information classification “address”, although the necessity or unnecessity of masking is “necessity”, the position of a region has not been able to be acquired. When wanting to designate a region in this situation, the user can press the region position edit button 1135 and select a rectangular region. The display control unit 427 sets the selected rectangular region as the position of a region for an item corresponding to the information classification “address” and thus updates the masking information list as a masking information list with a masking region added thereto as shown in Table 4.

TABLE 4
Masking Information List with Masking Region Added thereto

| | Character string | | Position of region |
|---|---|---|---|
| | corresponding to | Necessity or | (coordinates of |
| Information | information | unnecessity | starting point |
| classification | classification | of masking | and ending point) |
| Company name | ∘∘∘ Kabushiki | unnecessity | (141, 161), |
| | Kaisha | | (397, 345) |
| Full name | Kiyano | necessity | (341, 461), |
| | | | (997, 545) |
| Full name | Tanaka | necessity | (510, 461), |
| | | | (1166, 545) |
| Phone number | xxx-∘∘∘∘-□□□□ | necessity | (441, 557), |
| | | | (1369, 653) |
| Address | — (none) | necessity | (1853, 41), |
| | | | (2373, 133) |

In step S803, the display control unit 427 determines whether a user operation has been detected on the preview screen 1100 via the UI display unit 414. If it is determined that a user operation has been detected on the preview screen 1100 (YES in step S803), the display control unit 427 advances the processing to step S811. If it is determined that no user operation has been detected (NO in step S803), the display control unit 427 repeats step S803 to wait for a user operation. In step S811, the display control unit 427 determines whether the user operation detected in step S803 is a user operation which presses the print button 1114. If it is determined that the detected user operation is a user operation which presses the print button 1114 (YES in step S811), the display control unit 427 ends the processing in the present flowchart. If it is determined that the detected user operation is not a user operation which presses the print button 1114 (NO in step S811), the display control unit 427 advances the processing to step S812. In step S812, the display control unit 427 determines whether the user operation detected in step S803 is a user operation which selects a document classification. Thus, the display control unit 427 determines whether a document classification has been reselected via the document classification selection drop-down list 1121. If it is determined that the detected user operation is a user operation which selects a document classification (YES in step S812), the display control unit 427 advances the processing to step S707. If it is determined that the detected user operation is not a user operation which selects a document classification (NO in step S812), the display control unit 427 advances the processing to step S813. A processing operation in step S707 is a processing operation similar to that in step S707 described above with reference to FIG. 7. In step S813, the display control unit 427 determines whether the user operation detected in step S803 is a user operation which issues an instruction for adding or deleting a masking region. The user operation which issues an instruction for adding a masking region is, for example, an operation which presses the masking instruction button 1112 or one of the region position edit buttons 1132 to 1136 and designates a region on the preview image display area 1101. Moreover, the user operation which issues an instruction for adding a masking region is an operation which selects a checkbox within the masking information display area 1130. The user operation which issues an instruction for deleting a masking region is an operation which presses the masking selection button 1113, selects a mask image displayed on the preview image display area 1101, and presses the masking deletion button 1111. If it is determined that the user operation detected in step S803 is a user operation which adds or deletes a masking region (YES in step S813), the display control unit 427 advances the processing to step S805. If it is determined that the user operation detected in step S803 is not a user operation which adds or deletes a masking region (NO in step S813), the display control unit 427 advances the processing to step S802, and thus updates a preview screen according to a user operation detected in step S803 and displays the updated preview screen. For example, in a case where the user operation detected in step S803 is a user operation which presses the preview display enlargement button 1102, the display control unit 427 enlarges a preview image and displays the preview screen in step S802. In step S805, the display control unit 427 acquires the coordinates of a masking region with respect to which an instruction for addition or deletion has been received, returns the processing to step S801, and then adds or deletes a mask image according to the instruction. Specifically, the display control unit 427 detects that the masking instruction button 1112 or any one of the region position edit buttons 1132 to 1136 has been pressed and an operation for designating a region on the preview image display area 1101 has been performed. Then, the display control unit 427 acquires a rectangular region selected on the touch panel via the UI display unit 414, and converts the acquired rectangular region into a rectangular region on a masking image displayed as a preview image. The display control unit 427 acquires masking information about image data targeted for editing, and adds the rectangular region obtained by conversion performed in step S805 to the masking information. The display control unit 427 adds, to the masking information, “rectangular region” as a masking classification, “- (none)” as a character string corresponding to the information classification, “necessity” as the necessity or unnecessity of masking, and a rectangular region obtained by conversion performed in step S805 as the position of a region (coordinates of starting point and ending point), and stores the masking information with such pieces of information added thereto in the RAM 213. An example of a masking information list in which the masking region has been added to the masking information in the above-described way is shown in Table 5 below.

TABLE 5
Masking Information List with Masking Region Added thereto

| | Character string | | Position of region |
|---|---|---|---|
| | corresponding to | Necessity or | (coordinates of |
| Information | information | unnecessity | starting point |
| classification | classification | of masking | and ending point) |
| Company name | ∘∘∘ Kabushiki | unnecessity | (141, 161), |
| | Kaisha | | (397, 345) |
| Full name | Kiyano | necessity | (341, 461), |
| | | | (997, 545) |
| Full name | Tanaka | necessity | (510, 461), |
| | | | (1166, 545) |
| Phone number | xxx-∘∘∘∘-□□□□ | necessity | (441, 557), |
| | | | (1369, 653) |
| Address | — (none) | necessity | (1853, 41), |
| | | | (2373, 133) |
| Rectangular | — (none) | necessity | (441, 957), |
| region | | | (1369, 1057) |

FIG. 9 is a flowchart illustrating preset registration processing in step S506 in the first exemplary embodiment. In step S901, the display control unit 427 determines whether a preset has been used in masking processing. Specifically, the display control unit 427 determines whether a masking mode included in nob information is preset selection or automatic. If it is determined that the masking mode is preset selection or automatic (YES in step S901), the display control unit 427 advances the processing to step S902, and, if it is determined that the masking mode is neither preset selection nor automatic (NO in step S901), the display control unit 427 advances the processing to step S903. In step S902, the display control unit 427 determines whether the preset selected in step S608 has been edited in response to an input from the user. Thus, the display control unit 427 determines whether the user has edited the preset on the preset detailed screen illustrated in FIG. 10F, 10G, or 10H and whether the user has edited the masking region on the preview screen 1100. For example, the display control unit 427 only needs to determine whether the final masking information coincides with masking information about the selected preset. If it is determined that the preset has been edited (YES in step S902), the display control unit 427 advances the processing to step S903, and, if it is determined that the preset has not been edited (NO in step S902), the display control unit 427 ends the processing in the present flowchart. In step S903, the display control unit 427 displays a screen (not illustrated) for inquiring of the user whether the user performs preset registration, on the operation unit 220 via the UI display unit 414.

In step S904, the display control unit 427 determines whether registration as a preset has been selected in response to an operation performed by the user. If it is determined that registration has been selected (YES in step S904), the display control unit 427 advances the processing to step S905, and, if it is determined that registration has not been selected (NO in step S904), the display control unit 427 ends the processing in the present flowchart. In step S905, the display control unit 427 requests the UI display unit 414 to display a preset registration screen on the operation unit 220. The preset registration screen is a screen available for registering the masking information in the first exemplary embodiment as a preset. In a case where the masking classification in the masking information includes only an information classification, the display control unit 427 generates a preset registration screen for information classification selection. In a case where the masking classification in the masking information includes only a rectangular region, the display control unit 427 generates a preset registration screen (not illustrated) for region designation.

FIG. 12 illustrates an example of a preset registration screen which the display control unit 427 displays on the operation unit 220 in step S905, and which is specifically a preset registration screen for information classification selection. The preset registration screen 1200 is configured with a preset name display area 1210, a document classification selection area 1220, a registration information display area 1230, a storage button 1203, and a cancel button 1204. The preset name display area 1210 displays a preset name to be registered, and receives a correction of the preset name. While, by default, a character string obtained by joining the name and serial number of a document classification selected in the document classification selection area 1220 described below by an underscore is set as a preset name, the preset name can be changed to an optional preset name by the user. The document classification selection area 1220 receives selection of a document classification to be registered.

By default, a document classification displayed in the document classification display area 1120 is set. The registration information display area 1230 is an area for displaying masking information displayed in the masking information display area 1130. The registration information display area 1230 is configured with respective information classification name display areas 1231, 1232, and 1233 and toggle buttons 1235, 1236, and 1237 available for selecting whether to cause respective information classifications to be included in a preset. In the case of each toggle button being set to ON, each information classification is registered with a preset as an information classification targeted for masking, and, in the case of each toggle button being set to OFF, each information classification is not registered with a preset. Initial displaying of each toggle button in the preset registration screen 1200 is set according to the necessity or unnecessity of masking in the masking information as with displaying of the masking information display area 1130. The storage button 1203 is a button for setting registration of pieces of information displayed in the areas 1210 to 1230 as a preset. The cancel button 1204 is a button for ending the preset registration screen 1200 in the first exemplary embodiment without performing the preset registration processing.

In step S906, the display control unit 427 requests the data management unit 424 to store the preset set in step S905. The data management unit 424 can store the preset in the external storage 120 via the Internet access unit 426, or can store the preset in the HDD 214 via the internal data storage unit 412. Here, in a case where a preset with the same name is already stored in the HDD 214 or the external storage 120, the display control unit 427 can request the operation unit 220 to display a warning for inquiring of the user whether to perform overwrite save. Moreover, in a case where preset registration has been normally completed, the display control unit 427 can request the operation unit 220 to display a message indicating that preset registration has been completed.

Furthermore, preset registration is configured to be also able to be preliminarily performed before scan is performed. A preset registration screen for that case is also similar to the preset registration screen 1200 illustrated in FIG. 12. A list of document classifications which the document classification determination unit 429 is able to determine is displayed in the document classification selection area 1220. As mentioned above, the list of document classifications is included in a machine learning model or a table for determining a document classification stored in the document classification determination unit 429, the data management unit 424, or the external storage 120. When displaying the preset registration screen, the display control unit 427 acquires information about document classifications from the data management unit 424 or the external storage 120 and thus displays a list of document classifications. In the registration information display area 1230, information classifications which the information detection unit 428 is able to detect are displayed. As mentioned above, a list of information classifications is included in the information detection unit 428, the data management unit 424, or the external storage 120. When displaying the preset registration screen, the display control unit 427 acquires information about information classifications from the data management unit 424 or the external storage 120 and thus displays a list of information classifications. The user is able to set, on the preset registration screen 1200, a preset name, a document classification, and information classifications to be associated with the document classification, which are to be registered as a preset. Information classifications to be registered as a preset are information classifications targeted for masking processing in image data for the document classification associated with the information classifications. In response to the storage button 1203 being pressed on the preset registration screen 1200, the display control unit 427 requests the data management unit 424 to store the fixed preset. The data management unit 424 can store the preset in the external storage 120 via the Internet access unit 426, or can store the preset in the HDD 214 via the internal data storage unit 412.

Implementing the first exemplary embodiment in the above-described processing procedure enables automatically determining a document classification and superposing a mask image on a character string region of a character string falling into an information classification corresponding to the document classification, thus generating a mask composite image. Moreover, selection or unselection of an item of an information classification using a preview screen enables editing a character string targeted for masking. Determining an item by an information classification corresponding to a document classification to perform or set masking provides an advantageous effect of reducing the number of operations to be performed by the user and a load to be imposed on the user at the time of execution of masking. Thus far is the description of the first exemplary embodiment.

In a second exemplary embodiment, suppose a case where, when a plurality of presets corresponding to the same document classification is present, any one of the presets has not been expressly designated by the user, i.e., the masking mode is automatic. A method of exhaustively extracting information classifications targeted for masking even in such a case is described with reference to the drawings. Furthermore, in the description of the second exemplary embodiment, portions identical in configuration or processing procedure to those in the first exemplary embodiment are omitted from description, and only portions different from those in the first exemplary embodiment are described.

In the second exemplary embodiment, a list of presets retained in the external storage 120 is shown in a preset list written in Table 6. The preset list is configured with a preset name, a document classification, and an information classification targeted for masking. The preset name is used for the external storage 120 to identify a preset. The preset name is the same as the name of a character string designated in the preset name display area 1210. In a case where the preset names overlap each other, identification is made by appending, for example, a serial number behind each preset name. Moreover, optional names can be used as long as they do not overlap each other.

In the preset list shown in Table 6, three presets are retained. With regard to the first preset, the preset name is “bill_01”, the document classification is “bill”, and the information classifications targeted for masking are “full name”, “phone number”, and “address”. With regard to the second preset, the preset name is “bill_02”, the document classification is “bill”, and the information classifications targeted for masking are “full name” and “e-mail address”. With regard to the third preset, the preset name is “contract_01”, the document classification is “contract”, and the information classifications targeted for masking is “document number”, “full name”, and “address”. The preset of “bill_02” is, for example, a preset newly created in a case where the preset of “bill_01” is already set in the preset registration screen 1200 and is stored in the preset list. In the preset registration screen 1200, a plurality of presets with respective different preset names can be created with respect to one document classification.

TABLE 6
Preset List

| | Document | Information classification targeted for |
|---|---|---|
| Preset name | classification | masking |
| bill_01 | bill | full name, phone number, address |
| bill_02 | bill | full name, e-mail address |
| contract_01 | contract | document number, full name, address |

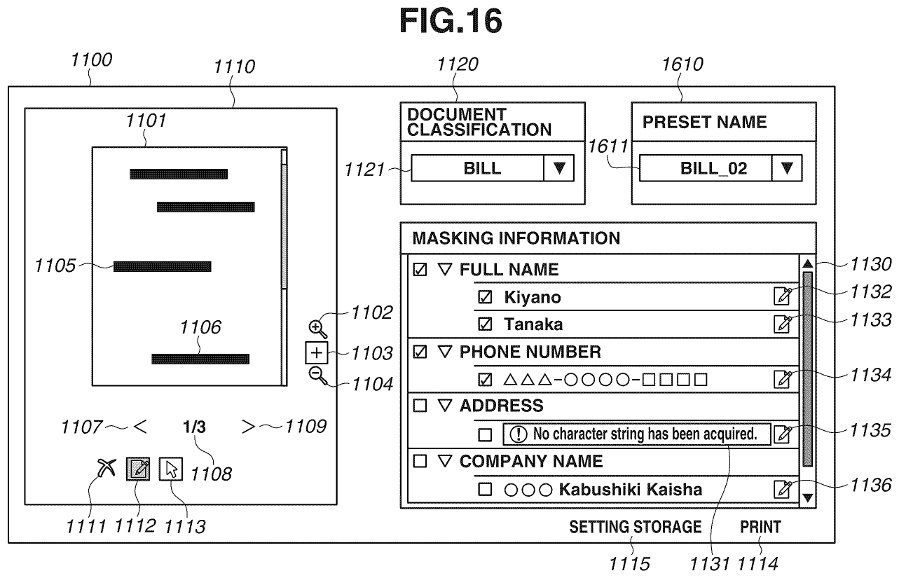

FIG. 16 illustrates a preview screen in the second exemplary embodiment. Only portions different from those of the preview screen (FIG. 11) in the first exemplary embodiment are described. The preview screen 1100 has a preset name display area 1610. The preset name display area 1610 has a preset name selection drop-down list 1611. The preset name selection drop-down list 1611 displays all of the preset names coincident with a document classification displayed in the document classification display area 1120 from among the preset list, and receives selection of a preset name from the user. For example, in a case where “bill” is selected in the document classification selection drop-down list 1121, preset names which are able to be selected in the preset name selection drop-down list 1611 are “bill_01” and “bill_02”. The initial value of the preset name selection drop-down list 1611 is displayed as blank indicating “not set”.

In a case where the preset name “bill_02” has been selected by the user, it is determinable that the information classifications targeted for masking are “full name” and “e-mail address”. On the other hand, in a case where any preset name is not yet set in the preset name selection drop-down list 1611, since it is impossible to determine a preset, it is also impossible to determine the information classification targeted for masking. To exhaustively acquire information classifications targeted for masking even in such a case, the display control unit 427 exhaustively acquires information classifications targeted for masking corresponding to the document classification “bill”, and exhaustively presents the acquired information classifications to the user. Exhaustively presenting the information classifications targeted for masking enables, even with respect to an information classification other than the information classifications targeted for masking, performing masking processing only by an operation for unselecting a checkbox for the information classification.

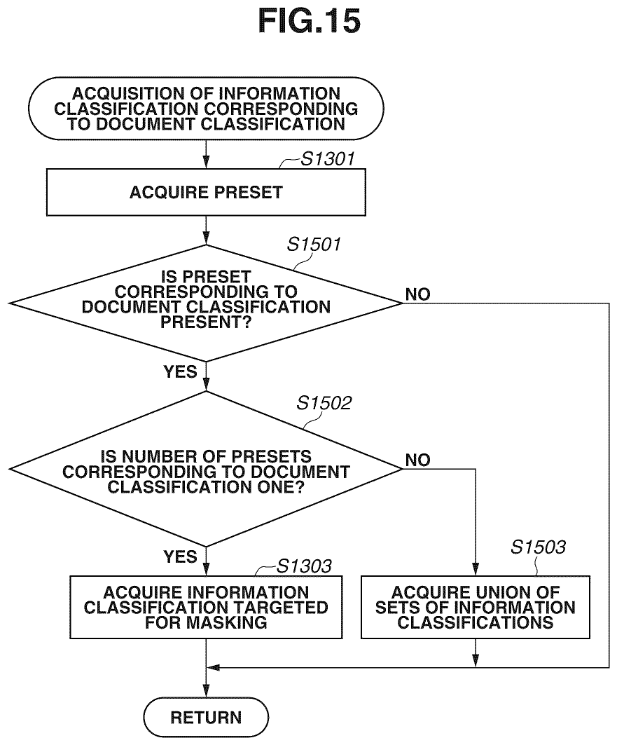

FIG. 15 is a flowchart in a case where a plurality of presets corresponding to a document classification is present and any preset is not expressly selected from the preset name selection drop-down list 1611 by the user, in the second exemplary embodiment. The flowchart of FIG. 15 illustrates a method of exhaustively acquiring information classifications targeted for masking in such a case. Only portions different from those in the flowchart (FIG. 13) for acquiring an information classification corresponding to a document classification in the first exemplary embodiment are described. The processing in the present flowchart is implemented by the control unit 210.

In step S1501, the masking information classification identification processing unit 430 determines whether a preset corresponding to the document classification determined in step S704 is present in the presets acquired in step S1301. If it is determined that a preset corresponding to the document classification is present (YES in step S1501), the masking information classification identification processing unit 430 advances the processing to step S1502, and, if it is determined that a preset corresponding to the document classification is not present (NO in step S1501), the masking information classification identification processing unit 430 ends the processing in the present flowchart. In the second exemplary embodiment, as the presets acquired in step S1301, two presets with respective preset names “bill_01” and “bill_02” are present.

In step S1502, the masking information classification identification processing unit 430 determines whether the number of presets corresponding to the document classification determined in step S704 is one. If it is determined that the number of presets is one (YES in step S1502), the masking information classification identification processing unit 430 advances the processing to step S1303, and, if it is determined that the number of presets is not one, i.e., is two or more (NO in step S1502), the masking information classification identification processing unit 430 advances the processing to step S1503.

In step S1503, the masking information classification identification processing unit 430 acquires information classifications in such a manner that information classifications targeted for masking become a union of sets from the acquired presets, stores the acquired union of sets in the RAM 213, and then ends the processing in the present flowchart.

While, in the second exemplary embodiment, a union of sets is used, a preset which is large in the number of items of information classifications targeted for masking can be acquired. Moreover, degrees of priority can be set to presets and information classifications can be determined based on the degrees of priority.

In the second exemplary embodiment, the information classifications targeted for masking which are set by the preset with a preset name “bill_01” are “full name”, “phone number”, and “address”. Moreover, the information classifications targeted for masking which are set by the preset with a preset name “bill_02” are “full name” and “e-mail address”. The union of sets of information classifications targeted for masking which are set by the preset with a preset name “bill_01” and the preset with a preset name “bill_02” becomes “full name”, “phone number”, “address”, and “e-mail address”. Therefore, the information classifications targeted for masking in the present flowchart becomes “full name”, “phone number”, “address”, and “e-mail address”. The masking information classification identification processing unit 430 sets the necessity or unnecessity of masking corresponding to each of the obtained information classifications to “necessity”, thus generating masking information.

An example of the masking information in the second exemplary embodiment is shown in a masking information list written in Table 7. The masking information list is a list obtained by adding information about an information classification “e-mail address” to the masking information list written in Table 3. Specifically, in the added information about an information classification “e-mail address”, a character string corresponding to the information classification is “kiyano@example.com”, the necessity or unnecessity of masking is “necessity”, and the position of a region is “(707, 1555), (877, 1629)”.

TABLE 7
Masking Information List

| | Character string | | Position of region |
|---|---|---|---|
| | corresponding to | Necessity or | (coordinates of |
| Information | information | unnecessity | starting point and |
| classification | classification | of masking | ending point) |
| Company | ∘∘∘ Kabushiki | unnecessity | (141, 161), |
| name | Kaisha | | (397, 345) |
| Full name | Kiyano | necessity | (341, 461), |
| | | | (997, 545) |
| Full name | Tanaka | necessity | (510, 461), |
| | | | (1166, 545) |
| Phone number | xxx-∘∘∘∘-□□□□ | necessity | (441, 557), |
| | | | (1369, 653) |
| Address | — (none) | necessity | — (none) |
| E-mail address | kiyano@example.com | necessity | (707, 1555), |
| | | | (877, 1629) |

With the second exemplary embodiment being implemented in the above-described processing procedure, even in a case where, although a plurality of presets corresponding to a document classification is present, any one of the presets has not been expressly designated, it is possible to perform masking processing. Specifically, all of the information classifications the necessity or unnecessity of masking of each of which is set to “necessity” are displayed in the preview screen 1100, thus enabling the user to perform checking. Moreover, it is possible to prevent omission of masking only by an operation which unselects a checkbox with respect to only a character string for which not to perform masking. Thus far is the description of the second exemplary embodiment.

In a third exemplary embodiment, enabling more accurately and more easily using a preset is described with reference to the drawings. Furthermore, in the description of the third exemplary embodiment, portions identical in configuration or processing procedure to those in the first and second exemplary embodiments are omitted from description, and only portions different from those in the first and second exemplary embodiments are described.

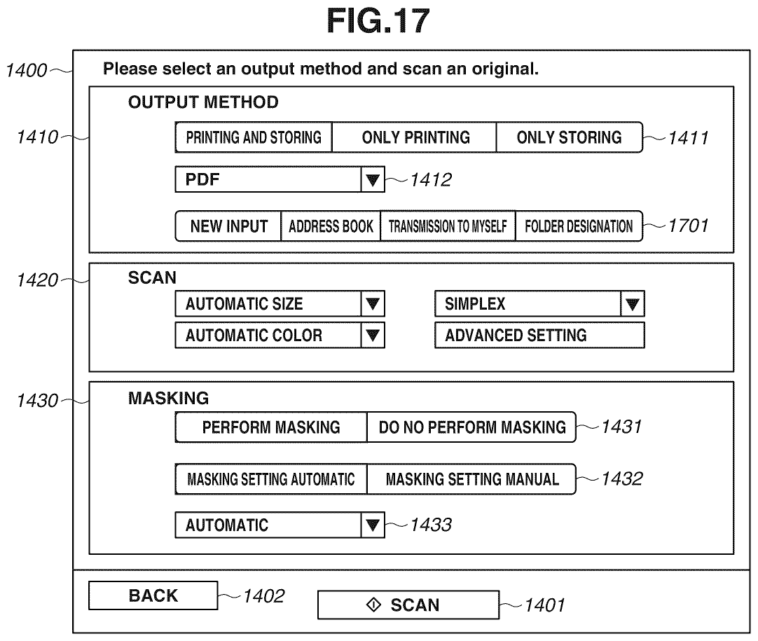

FIG. 17 illustrates a scan setting screen in the third exemplary embodiment. In the third exemplary embodiment, the scan setting screen is displayed after an authentication server (not illustrated) identifies the user based on user information input by the user via the operation unit 220. Portions different from those in the scan setting screen (FIG. 14) in the first exemplary embodiment are described. The output method setting area 1410 includes an output destination designation button 1701. The output destination designation button 1701 is an item used to designate a transmission destination of a masking image which is available when the output method selection button 1411 is set to “printing and storing” or “only storing”.

The output destination designation button 1701 allows selection of any one of buttons “new input”, “address book”, “transmission to myself”, and “folder designation”. The button “new input” is a button for setting the transmission destination of a masking image via the operation unit 220. The transmission destination includes, in addition to the HDD 214 and the external storage 120, a portion designated by an Internet Protocol (IP) address via the network I/F 219. The button “address book” is a button for inputting an e-mail address and transmitting an e-mail with a masking image attached thereto. The button “transmission to myself” is a button which is available to be used after an authentication server (not illustrated) identifies the user based on user information input by the user via the operation unit 220. The authentication server sets an e-mail address which has been registered based on the authenticated user information. The button “folder designation” is a button which is available by preliminarily setting a cloud service or file server as the transmission destination of a masking image via the operation unit 220. As with the button “transmission to myself”, the button “folder designation” is a button capable of facilitating setting of an output destination by preliminary registering a transmission destination high in frequency of use by the user.

For example, in the button “folder designation”, “project folder” is preliminarily set as a transmission destination. The project folder is a folder which a plurality of relevant persons subjected to access limitation is allowed to access. Moreover, the output destination designation button 1701 can be configured to further include another storage destination button.

An example of a list of presets retained in the external storage 120 in the third exemplary embodiment is shown in a preset list written in Table 8. The preset list is configured with a preset name, a document classification, an information classification targeted for masking, and an output destination condition. Although not illustrated, a preset registration screen 1200 in the third exemplary embodiment further includes an area for receiving an output destination condition, i.e., designation of a transmission destination. The designation received in this area is then retained in, for example, the external storage 120 as shown in Table 8 while being associated with a document classification. Furthermore, in the third exemplary embodiment, the preset list is retained while being linked with user information about a user who uses the MFP 110. When acquiring a preset in step S1301, the masking information classification identification processing unit 430 acquires a preset corresponding to user information input via the operation unit 220 of the MFP 110.

The preset list is a list obtained by adding presets with respective preset names “bill_3” and “bill_4” to the preset list shown in Table 6 in the second exemplary embodiment. The preset with a preset name “bill_3” is a preset in which the document classification is “bill”, the information classification targeted for masking is “address”, and the output destination condition is “transmission to myself”. The preset with a preset name “bill_4” is a preset in which the document classification is “bill”, the information classification targeted for masking is “phone number” and “address”, and the output destination condition is “project folder in folder designation”.

TABLE 8
Preset List

| | | | Output |
|---|---|---|---|
| Preset | Document | Information classification | destination |
| name | classification | targeted for masking | condition |
| bill_01 | bill | full name, phone number, | — (none) |
| | | address | |
| bill_02 | bill | full name, e-mail address | — (none) |
| contract_01 | contract | document number, full | — (none) |
| | | name, address | |
| bill_3 | bill | address | transmission |
| | | | to myself |
| bill_4 | bill | phone number, address | project folder |
| | | | in folder |
| | | | designation |

In a case where the document classification is “bill”, when information classifications targeted for masking are acquired in step S706, the corresponding preset names are four names, i.e., “bill_01”, “bill_02”, “bill_3”, and “bill_4”. In the second exemplary embodiment, the information classifications targeted for masking at this time become “full name”, “phone number”, “address”, and “e-mail address”. The masking information display area 1130 is displayed with respective checkboxes for the information classifications “full name”, “phone number”, “address”, and “e-mail address” being preliminarily selected.

On the other hand, in the third exemplary embodiment, when information classifications targeted for masking are acquired in step S706, a preset is identified based on a document classification and an output destination condition, and an information classification associated with the identified preset is acquired. For example, consider a case where the document classification determined in step S704 is “bill” and “transmission to myself” is selected in the output destination designation button 1701 in step S501. In this case, based on the preset list shown in Table 8, a preset in which the document classification is “bill” and the output destination condition is “transmission to myself” is identified.

Since the corresponding preset is only a preset with a preset name “bill_3”, “address” is acquired as an information classification targeted for masking. The masking information display area 1130 is displayed with a checkbox for the information classification “address” being preliminarily selected and with respective checkboxes for the information classifications “full name”, “phone number”, and “e-mail address” being unselected.

Compared with a case where an information classification targeted for masking is determined based on only information classifications, it is possible to reduce the number of operations by the user concerning checkboxes included in the masking information display area 1130.

Similarly, a preset which is acquired in a case where a project folder has been designated by “folder designation” is only a preset with a preset name “bill_4”. The information classifications targeted for masking become “phone number” and “address”. The masking information display area 1130 is displayed with respective checkboxes for the information classifications “phone number” and “address” being preliminarily selected and with respective checkboxes for the information classifications “full name” and “e-mail address” being unselected.

In a case where a project folder has been designated by “folder designation”, since a plurality of persons is allowed to access the project folder, it is possible to set an item targeted for masking corresponding to persons having access authority.

Moreover, in a case where “transmission to myself” has been designated, it is possible to further perform masking only at minimum.

With the third exemplary embodiment being implemented in the above-described processing procedure, determining a preset and an information classification targeted for masking with use of an output destination designation in addition to a document classification enables reducing the number of operations by the user in the preview screen 1100. Additionally, determining an information classification targeted for masking with designation of an output destination enables performing masking in just proportion.

Thus far is the description of the third exemplary embodiment.

In a fourth exemplary embodiment, enabling easily implementing a reduction in processing load and a speed-up of processing for document classification determination processing is described with reference to the drawings. Furthermore, in the description of the fourth exemplary embodiment, portions identical in configuration or processing procedure to those in the first, second, and third exemplary embodiments are omitted from description, and only portions different from those in the first, second, and third exemplary embodiments are described.

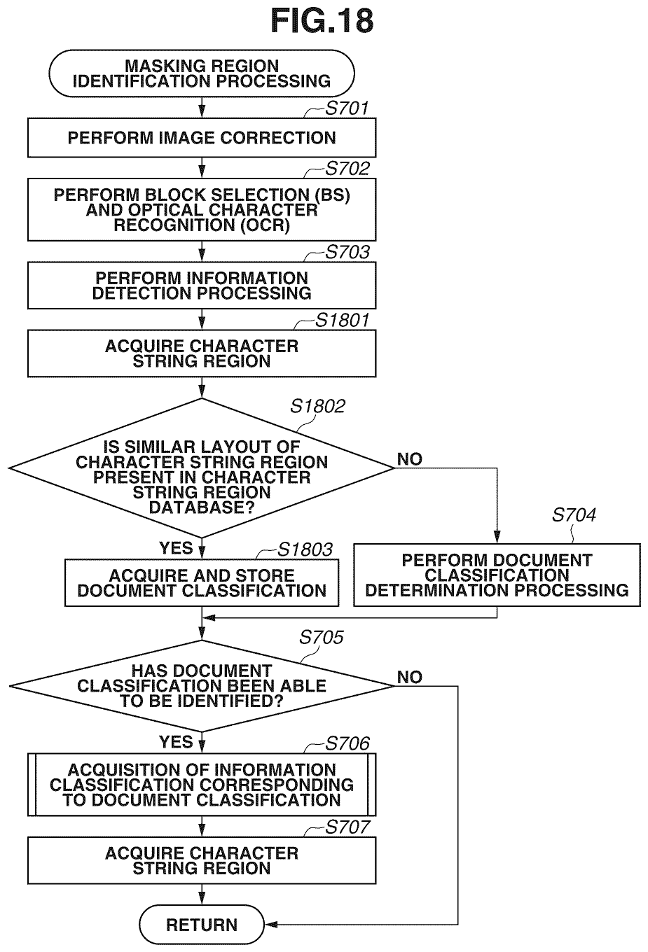

FIG. 18 is a flowchart illustrating a method of reducing a processing load of the document classification determination processing (step S704) by the document classification determination unit 429 in the masking region identification processing (step S503). The processing in the present flowchart is implemented by the control unit 210.

In step S1801, the image processing unit 423 acquires one or more character string regions from the RAM 213.

In step S1802, the image processing unit 423 determines whether a layout of one or more character string regions similar to a layout of the one or more character string regions extracted in step S702 and acquired in step S1801 is present in a character string region database. If it is determined that a similar layout of one or more character string regions is present (YES in step S1802), the image processing unit 423 advances the processing to step S1803, and, if it is determined that a similar character string region is not present (NO in step S1802), the image processing unit 423 advances the processing to step S704.

The character string region database retains one or more character string regions preliminarily registered by the user as one document layout in the HDD 214. Additionally, the character string region database retains the document layout and document classifications in the HDD 214 while associating them with each other. Moreover, a similar business-form registration button (not illustrated) can be provided in such a way as to store a character string region acquired in step S702 and document classifications in association with each other at the time of preset registration. The similar business-form registration button is used for the user to select a character string region to be registered as a document layout from among character string regions acquired in step S702 and register the selected character string region in the character string region database.

The number of times of use of a character string region and an information classification can be preliminarily retained in the RAM 213, and, in a case where the number of times of use has become greater than or equal to a threshold value, the character string region and the information classification can be registered in the character string region database.

In performing similarity determination, the area of a common region obtained when a character string region stored in the character string region database and a character string region acquired in step S702 are superposed on each other with the upper left coordinates of them made coincident with each other is used. If the proportion of the area of the common region to the area of the character string region stored in the character string region database or the area of the character string region acquired in step S702 is greater than or equal to a threshold value, it is determined that there is a similarity. The area of a character string region refers to the area of a rectangle formed by coordinates representing the character string region.

In step S1803, the image processing unit 423 acquires, from the character string region database, a document classification corresponding to the similar character string region, and stores the acquired document classification in the RAM 213.

With the fourth exemplary embodiment being implemented in the above-described processing procedure, performing similarity determination using a character string region enables performing document classification determination, so that it is possible to reduce a processing load on the document classification determination unit 429.

Thus far is the description of the fourth exemplary embodiment.

The present disclosure can also be implemented by processing for supplying a program for implementing one or more functions of the above-described exemplary embodiments to a system or apparatus via a network or a storage medium and causing one or more processors included in a computer of the system or apparatus to read out and execute the program. Moreover, the present disclosure can also be implemented by a circuit which implements one or more functions of the above-described exemplary embodiments (for example, an application specific integrated circuit (ASIC) or a Field Programmable Gate Array (FPGA)).

According to an aspects of the present disclosure, an information processing apparatus capable of performing masking processing on character strings falling into items which differ for each type of image data can be provided.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-111114 filed Jul. 6, 2023, which is hereby incorporated by reference herein in its entirety.

What is claimed is:

1. An information processing apparatus comprising:
at least one memory that stores instructions; and
at least one processor that executes the instructions to perform operations comprising:
based on recognition processing for identifying a classification of image data, identifying a classification of the image data from among a plurality of classifications;
searching for a character string falling into a category associated with the identified classification from among a plurality of character strings included in the image data; and
performing masking processing on the searched-for character string in the image data,
wherein each of the plurality of classifications are associated with different categories.

2. The information processing apparatus according to claim 1, wherein the operations further comprise:
receiving, from a user, designation of categories associated with the plurality of classifications;
setting each of the designated categories in association with the different one of the plurality of classifications; and
a character string falling into the category set in association with the identified classification is searched for from among the plurality of the character strings in the image data.

3. The information processing apparatus according to claim 2, wherein the operations further comprise:
with respect to one classification from among the plurality of classifications, in association with which a first category has previously been set, receiving new designation of a second category; and
in a state in which the previously set first category has been set in association with the one classification, further setting the newly designated second category in association with the one classification.

4. The information processing apparatus according to claim 3, wherein the operations further comprise searching for a character string falling into the first category and a character string falling into the second category, wherein both the first category and the second category are associated with the identified classification.

5. The information processing apparatus according to claim 2, wherein the operations further comprise:
in association with the plurality of classifications, further receiving, from the user, designation of transmission destinations in addition to designation of the categories;
setting each of the transmission destinations in association with the different one of the plurality of classifications; and
in a case where a transmission destination of the image data has been set in association with the identified classification, a character string falling into a category set in association with the identified classification is searched for.

6. The information processing apparatus according to claim 1, wherein the operations further comprise:
providing a screen including the image data displayed with the searched-for character string masked and categories including the category associated with the identified classification;
receiving, from a user via the screen, an instruction for selecting or unselecting the categories as a target for masking processing in the image data;
in a case where the received instruction is an instruction for selecting, as a target for masking processing, one category which is not selected from among the categories, displaying the image data in the screen while masking a character string falling into the selected one category; and
in a case where the received instruction is an instruction for canceling selection as a target for masking processing of selected one category from among the categories, displaying the image data in the screen without masking a character string falling into the selected one category.

7. The information processing apparatus according to claim 1, further comprising a scanner,
wherein the operations further comprise obtaining the image data by scanning a document with the scanner.

8. The information processing apparatus according to claim 1, further comprising a printer,
wherein the operations further comprise causing the printer to print the image data subjected to the masking processing.

9. The information processing apparatus according to claim 1, wherein the operations further comprise storing the image data subjected to the masking processing in a storage of the information processing apparatus or a storage of an external apparatus.

10. The information processing apparatus according to claim 1, wherein the operations further comprise acquiring a character string falling into a category associated with the identified classification from an external apparatus and searching for the character string from among a plurality of character strings included in the image data.

11. A control method for an information processing apparatus, the control method comprising:
based on recognition processing for identifying a classification of image data, identifying a classification of the image data from among a plurality of classifications;
searching for a character string falling into a category associated with the identified classification from among a plurality of character strings included in the image data; and
performing masking processing on the searched-for character string in the image data,
wherein each of the plurality of classifications are associated with different categories.

12. A non-transitory computer-readable storage medium storing computer-executable instructions that, when executed by a computer, cause the computer to perform a control method for an information processing apparatus, the control method comprising:
based on recognition processing for identifying a classification of image data, identifying a classification of the image data from among a plurality of classifications;
searching for a character string falling into a category associated with the identified classifications from among a plurality of character strings included in the image data; and
performing masking processing on the searched-for character string in the image data,
wherein each of the plurality of classifications are associated with different categories.
